(19) United States
(12) Patent Application Publication
(10) Pub. No.: US 2025/0383835 A1
(43) Pub. Date: Dec. 18, 2025

(54) DESKTOP PLAYBACK DEVICE

(71) Applicant: Sonos Inc., Goleta, CA (US)

(72) Inventors: Shilpa Sarode, Boston, MA (US); Zach Buchman, Sacramento, CA (US); Jennifer Iudice, Seattle, WA (US); Neil Griffiths, Boston, MA (US); Katie Inglis, Austin, TX (US); Kristen Leclerc, Boston, MA (US)

(21) Appl. No.: 19/236,004

(22) Filed: Jun. 12, 2025

Related U.S. Application Data
(60) Provisional application No. 63/659,067, filed on Jun. 12, 2024.

(51) Int. Cl. G06F 3/16; H04R 1/02

(52) U.S. Cl. CPC G06F 3/165; H04R 1/02

(57) ABSTRACT

Playback devices and methods performed by same. In one example, a playback device includes a plurality of audio transducers and a communication interface. The playback device can be configured to play back first audio content via the plurality of audio transducers, while playing back the first audio content, detect, via the first communication interface, a first indication of incoming second audio content associated with a telecommunications session hosted on an external computing device, based on the first indication, transition from playing back the first audio content to causing playback of the second audio content, detect, after detecting the first indication, a second indication associated with termination of the telecommunications session, and revert, based on the second indication, to playback of the first audio content via the plurality of audio transducers.

### CROSS REFERENCE TO RELATED APPLICATION

This application claims priority under 35 U.S.C. § 119 (e) to co-pending U.S. Provisional Application No. 63/659,067 filed on Jun. 12, 2024, which is hereby incorporated herein by reference in its entirety for all purposes.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when Sonos, Inc. began development of a new type of playback system. Sonos then filed one of its first patent applications in 2003, entitled “Method for Synchronizing Audio Playback between Multiple Networked Devices,” and began offering its first media playback systems for sale in 2005. The SONOS Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIGS. 1I through 1L are schematic diagrams of corresponding media playback system zones.

FIG. 1M is a schematic diagram of media playback system areas.

FIG. 2A is a perspective view of an example of a playback device configured in accordance with aspects of the disclosed technology.

FIG. 2B is a transparent view of an example of a playback device configured in accordance with aspects of the disclosed technology.

FIG. 3A is a front isometric view of an example of a playback device configured in accordance with aspects of the disclosed technology.

FIG. 3B is a back isometric view of an example of the playback device of FIG. 3A.

FIG. 3C is a top view of an example of the playback device of FIG. 3A.

FIG. 4 is a block diagram of one example of a system in accordance with aspects of the disclosed technology.

FIG. 5 is a flow diagram of an example of a process of operating a playback device in accordance with aspects of the disclosed technology.

FIG. 6 is a flow diagram of another example of a process of operating of a playback device, in accordance with aspects of the disclosed technology.

FIG. 7 is a flow diagram of another example of a process of operating of a playback device, in accordance with aspects of the disclosed technology.

FIG. 8 is a flow diagram of an example of a portion of the process of any of FIGS. 5-7, in accordance with aspects of the disclosed technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Embodiments described herein relate to playback devices and, in particular, to playback devices configured to provide an enhanced user experience in certain system arrangements, such as when the playback device is used in a desktop arrangement. For example, as described further herein, playback devices according to certain aspects are configured to provide low-latency connectivity and communication with an external computing device and to allow the playback device to handle audio corresponding to audiovisual sessions hosted on the external computing device. Accordingly, a user engaged with the external computing device (e.g., working, playing a game, browsing the Internet, etc.) can listen to audio from the external computing device (e.g., audio from an online meeting or audio associated with a game or webpage) via the connected playback device. Further, in some examples, the playback device is configured to allow rapid, easy transition between playing first audio content (e.g., music, a podcast, etc.) an accepting second audio content from the external computing device that is associated with a telecommunications session (e.g., an online meeting) hosted by the external computing device. As described in more detail below, in some instances, this transition can be automatic in response to a trigger or notification of the incoming second audio content, and can accommodate numerous variations in the handling of both the first audio content and the second audio content when a transition is triggered. Accordingly, the playback device may facilitate a user's ability to listen to audio of choice while using the external computing device by providing a quick and easy way for the user to transition over to the telecommunications session without requiring numerous actions/decisions by the user to make the transition.

Many examples of playback devices are versatile and suitable for a wide variety of use cases. Whether used for engaged listening, background music, or in a home theater set-up, for example, these playback devices can deliver high performance and offer a pleasing sound experience to users. However, a home office or “desktop” scenario, in which a playback device is connected to an external computing device (e.g., a desktop or laptop computer) and used to playback audio content received from the external computing device (optionally in addition to other audio received from other sources) offers unique challenges. For example, there can be inherent latency between media playback on the external computing device and the corresponding audio output on the playback device. In some instances, this can be addressed by directly connecting the playback device to the external computing device via a TOSLINK or similar interface; however, this approach is not always successful. Depending on the playback device and/or external computing device, such connectivity may not be available or may not be simple to configure.

Furthermore, a significant barrier to users' ability to listen to audio content, such as background music, for example, while using the external computing device (or their comfort level with such listening) is a potential difficulty and/or delay in being able to stop (or otherwise alter, e.g., lower the volume of) the audio content when receiving a telephone call or incoming online meeting activity. When an unexpected call or meeting is incoming, for example, a user may have only a few seconds in which to turn off their generative audio and engage with the call/meeting. Fear of not being able to transition in time may prevent users from listening to background music, even though they would otherwise obtain enjoyment and/or potential productivity enhancement from doing so.

Accordingly, techniques are described herein for configuring a playback device to enhance the desktop experience. As described further below, examples of a desktop playback device are configured to interface with an external computing device to provide certain capabilities. As used herein, the term “desktop playback device” is intended to refer to a playback device having certain features and functionality described herein and relating to using the playback device in conjunction with an external computing device. However, the desktop playback device is not limited to use in conjunction with an external computing device, nor to being located on a desk.

In some examples, the desktop playback device is configured to provide rapid, dynamic switching (referred to as a playback transition) between out-loud listening via the desktop playback device (e.g., for background music or other audio) and audio/video conference audio via either the desktop playback device or another playback device, such as a user's wearable device (e.g., over-car or in-car headphones, smart-watches, extended reality devices, such as a headset, eyeglasses, etc.). In some instances, this switching can be performed manually through user input received via the external computing device, the desktop playback device, and/or the other playback device. In other examples, the desktop playback device and the external computing device can communicate to provide information regarding the user's calendar and/or status, and this information can be used to trigger a playback transition, as described further below. In addition, in some examples, the user interface (UI) of the desktop playback device includes buttons or other features that correspond to frequently used functions. These may include features that allow the user to indicate availability or quickly contact individuals with whom the user frequently interacts.

In some examples, the desktop playback device includes a housing having an elongated form factor. As described further below, an elongated form factor is intended to refer to a shape in which one lateral dimension (e.g., length) significantly exceeds another lateral dimension (e.g., width). In some examples, the desktop playback device includes one or more audio transducers configured to direct the acoustic output toward the user, taking advantage of the user's likely placement within the nearfield (e.g., ˜1.5 meters or closer) of the device. These and other features are described in more detail below.

In some examples, there is provided a playback device comprising a plurality of audio transducers, a first communication interface, at least one processor, and at least one non-transitory computer-readable storage medium storing program instructions that are executable by the at least one processor to cause the playback device to perform a plurality of actions. In some examples, these actions include to play back first audio content via the plurality of audio transducers, and while playing back the first audio content, detect, via the first communication interface, a first indication of incoming second audio content associated with a telecommunications session hosted on an external computing device. Based on the first indication, the playback device may transition from playing back the first audio content to causing playback of the second audio content. Further, in some examples, after detecting the first indication, the playback device may detect a second indication associated with termination of the telecommunications session and revert, based on the second indication, to playback of the first audio content via the plurality of audio transducers.

These and other examples and aspects described herein improve upon earlier-developed systems and methods including, for example, systems and methods disclosed and described in the following earlier-filed patent applications assigned to Sonos, Inc.

U.S. Pat. No. 8,234,395 titled, “System and Method for Synchronizing Operations Among a Plurality of Independently Clocked Digital Data Processing Devices,” filed on Apr. 1, 2004 and issued on Jul. 31, 2012 (“Millington '395) describes, among other features, examples of synchronizing audio playback among a plurality of playback devices or groups of playback devices.

U.S. Pat. No. 10,712,997 titled “Room Association Based on Name,” filed on Aug. 21, 2017 and issued on Jul. 14, 2020 (“Wilberding '997”) describes, among other features, using playback device attributes by a controller application to control one or more playback devices in a media playback system. According to Wilberding '997, the playback device attributes can include one or more of (i) a player name for the playback device, (ii) a player type of the playback device, (iii) a player icon for the playback device, (iv) a player configuration for the playback device, (v) a zone name for a zone associated with the playback device (e.g., the “downstairs zone” or “bedroom zone”), (vi) a session name for a session associated with the playback device, (vii) a room name where the playback device is located, (viii) a room type where the playback device is located, or (ix) a name of an area where the playback device is located (e.g., “downstairs” or “patio”). According to Wilberding '997, the controller application can be installed on a control device that may present a graphical user interface to facilitate user access and control of the media playback system, optionally using one or more of the playback device attributes.

U.S. Pat. No. 8,483,853 titled “Controlling and Manipulating Groupings in a Multi-zone Media System,” filed on Sep. 11, 2007 and issued on Jul. 9, 2013 (“Lambourne '853”) describes, among other features, techniques of controlling a plurality of multimedia players in groups. According to Lambourne '853, a user can group some of the players according to a theme or scene, where each of the players is located in a zone. Lambourne '853 discloses that when the scene is activated, the players in the scene react in a synchronized manner. For example, the players in the scene can all be caused to play a multimedia source or music in a playlist, wherein the multimedia source may be located anywhere on a network.

U.S. Pat. No. 9,094,706 titled “Systems and Methods for Wireless Music Playback,” filed on Oct. 19, 2012 and issued on Jul. 28, 2015 (“Reily '706”) describes, among other features, an interface between a computing device and playback device that provides communication between the devices.

U.S. Pat. No. 9,665,339 titled “Methods and Systems to Select an Audio Track,” filed on Dec. 28, 2011 and issued on May 30, 2017 (“Reimann '339”) discloses selecting a particular audio track for presentation to a user based on a playback condition matching a property of the particular audio track. Reimann '339 describes, among other features, that a detector of an audio source selection system can use an internal clock and/or calendar to determine a time-related playback condition detection.

U.S. Pat. No. 10,656,902 titled “Music Discovery Dial,” filed on Mar. 5, 2018 and issued on May 19, 2020 (“Kotelly '902”) describes, among other features, command interfaces having personalized touch sensitive regions associated with respective audio channels. For example, Kotelly '902 describes that a user may tune to a particular audio channel by directly selecting the corresponding selectable region of a user interface that is associated with the particular audio channel. According to Kotelly '902, different selectable regions of the user interface can be associated with different audio channels.

U.S. Pat. No. 8,788,080 titled “Multi-channel Pairing in a Media System” filed on Apr. 8, 2011 and issued on Jul. 22, 2014 (Kallai '080”) describes, among other features, techniques for grouping, consolidating, and/or pairing two or more playback devices together to create or enhance multi-channel audio reproduction, such as stereo, surround sound, or some other multi-channel reproduction.

U.S. Pat. No. 10,499,146 titled “Voice Control of a Media Playback System,” filed on Feb. 21, 2017 and issued on Dec. 3, 2019 (“Lang '146”) discloses voice control and related features and functionality for media playback devices, networked microphone devices, microphone-equipped media playback devices, and speaker-equipped networked microphone devices. Lang '146 describes, among other features, designating and managing default networked devices, audio response playback, room-corrected voice detection, content mixing, music service selection, metadata exchange between networked playback systems and networked microphone systems, handling loss of pairing between networked devices, actions based on user identification, and other voice control of networked devices.

U.S. Patent Publication No. 2022/0122583 titled “Intent Inference in Audiovisual Communication Sessions,” filed on Oct. 14, 2021 and published on Apr. 21, 2022 (“Bates '2583”) discloses, among other features, determining user intent based on utterances received via a network microphone device during an audiovisual (AV) communication session. According to Bates '2583, a user's intent can be inferred based on voice analysis during a communications session, and prompts can be presented, or other actions taken, at least partly in response to the inferred intent. For example, a network microphone device (NMD) having one or more microphones can capture voice input and transmit the voice input to remote computing device(s) for a communication session (e.g., a videoconference). According to Bates '2583, the NMD can analyze the voice input to detect one or more utterances, and based on the utterance(s), the NMD can cause a user prompt to be displayed via a display device communicatively coupled to the NMD. Bates '2583 discloses that the particular prompt can depend at least in part on one or more context parameters associated with the communication session (e.g., a microphone state of one or more users, a screen share state of one or more users, or a recording status of the session, etc.).

U.S. Pat. No. 8,938,312 titled “Smart Line-in Processing,” filed on Apr. 18, 2011 and issued on Jan. 20, 2015 (“Millington '312”) describes, among other features, examples of automated source switching in an audio environment where a playback device is capable of playing audio data from two or more different sources and at least one of the sources receives its audio data from an audio device via a line-in connection. According to Millington '312, the system can be configured to detect a line-in signal and automatically switch the source of the playback device to play from the audio device connected via the line-in connection. As such, a listener does not have to manually switch the source of the playback device before playing the audio from the audio device. Millington '312 discloses that the playback device may implement automatic source switching, such that when a signal is detected on the line-in connector, the playback device automatically triggers the audio from the audio device to be played by the playback device itself, to be played by another device in communication with this playback device, or by both. According to Millington '312, the automatic switch to play audio from the audio device may optionally be performed only after a signal is detected on the line-in connector for a threshold time.

U.S. Pat. No. 9,973,851 titled “Multi-channel Playback of Audio Content,” filed on Dec. 1, 2014 and issued on May 15, 2018 (“Chamness '851”) discloses, among other features, adjusting radiation patterns of a playback device based on orientation (and/or other parameters). According to Chamness '851, multi-channel playback of audio content (using multiple audio drivers and/or multiple playback devices) may enhance a listener's experience by causing the listener to perceive a balanced directional effect when the audio content is played back. Chamness '851 discloses that, in order to widen an area over which a balanced directional effect may be perceivable, signal processing may be used to produce target radiation patterns corresponding to different sets of audio drivers. Chamness '851 describes generating transfer functions based on the desired target radiation patterns and causing individual drivers to output sound accordingly. In some examples, the drivers include those that are oriented upward toward a ceiling of a room.

U.S. Pat. No. 9,736,610 titled “Manipulation of Playback Device Response Using Signal Processing,” filed on Aug. 21, 2015 and issued on Jul. 26, 2017 (“Chamness '610”) describes outputting multiple audio channels using a multiple driver playback device. According to Chamness '610, each group of audio driver(s) may be configured to generate sound waves corresponding to a certain audio channel according to a particular radiation pattern. Chamness discloses that such radiation patterns may define a direction-dependent amplitude of sound waves produced by the corresponding group of audio drivers (i) at a given audio frequency (or range of audio frequencies), (ii) at a given radius from the audio driver, (iii) for a given amplitude of input signal. According to Chamness '610, by controlling the relative amplitudes among various audio channels, the audio image (sound field) can be widened or narrowed. Chamness '610 further describes adjusting audio drivers for one or more audio channels to distribute responsibility for audio channel rendering among different transducers and along different sound axes in different scenarios and to achieve audio images with different perceived characteristics (such as perceived wideness).

U.S. Pat. No. 9,084,058 titled “Sound Field Calibration Using Listener Localization,” filed on Dec. 29, 2011 and issued on Jul. 14, 2015 (“Reily '058”) discloses detecting a listener's location and adjusting a sound field produced by a playback device based on the detected position of the listener. Reily '058 discloses that various location sensors can be used to triangulate the position of a listener, and then the listener's position can be used by a media playback system (e.g., home theater system software) to adjust the sound field accordingly.

U.S. Pat. No. 11,393,478 titled “User Specific Context Switching,” filed on Dec. 10, 2019 and issued on Jul. 19, 2022 (“Bates '478”) discloses detecting user(s) near a playback device and performing an action in response to (a) a user command and (b) a determination of which user issued the command.

U.S. Pat. No. 11,356,777 titled “Playback Transitions,” filed on Feb. 28, 2020 and issued on Jun. 7, 2022 (“Wilberding '777) describes, among other features, transitioning playback between an out-loud device and a headphone device (or vice versa) in response to a trigger. According to Wilberding '777, such transitions can be referred to herein as “swaps” or “playback session swaps,” and facilitate continuity of playback when transitioning between locations (e.g., from at home to on-the-go or vice versa) or between listening paradigms (e.g., personal or out-loud).

U.S. Pat. No. 11,483,670 titled “Systems And Methods Of Providing Spatial Audio Associated With A Simulated Environment,” filed on Oct. 30, 2019 and issued on Oct. 25, 2022 (“Torgerson '670”) describes, among other features, overlaying an extended reality scene (e.g., a virtual reality scene, an augmented reality scene, a mixed reality scene) onto a real environment. According to Torgerson '670, audio playback of an extended reality scene can be adjusted based on audio playback device position(s) and/or user position(s) with respect to the virtual scene. Conversely, Torgerson '670 also describes adjusting virtual scene characteristics (e.g., size, boundaries) based on audio playback device and/or user positions.

U.S. Pat. No. 11,985,376 titled, “Playback of Generative Media Content,” filed on Mar. 23, 2023 and issued on May 14, 2024 (“Wilberding '376”) describes, among other features, generating novel, synthetic media content according to one or more generative content model(s) and distributing the synthetic media content to one or more playback devices. According to Wilberding '376, a generative media coordinator generates synthetic media content based one or more input parameters. In some examples, the coordinator generates unique content for each of a plurality of devices [e.g., left audio content for a left device of a stereo pair and right audio content for a right device of a stereo pair, or perhaps audio content for an audio playback device and visual media content (e.g., images, video, text) for a device comprising a display (e.g., television, projector, computer)].

International Patent Publication No. WO/2023/225448 titled, “Generating Digital Media Based On Blockchain Data,” filed on May 9, 2023 (“Wilberding '448”) describes, among other features, generating media content based on data stored on a distributed ledger such as a blockchain and/or generating data that is stored on a distributed ledger. According to Wilberding '448, media content can be generated based on input parameters that may be stored as blockchain data on a public or private ledger distributed on local devices and/or remote devices. The input parameters may include sensor data, contextual data, listener history/preference data, etc. Under the approach of Wilberding '448, a smart contract can receive the stored blockchain data and generate media content accordingly. Alternatively, a generative content model can generate media content whose output affects or alters a smart contract.

International Patent Publication No. WO/2025/029673 titled “Systems and Methods for Maintaining Distributed Media Content History and Preferences,” filed on Jul. 26, 2024 (Butts '673) describes, among other things, storing and maintaining distributed media content history and preferences in media playback systems that include one or more blockchain-capable playback devices. According to Butts '673, content record sets, such as content experience record sets and content network record sets, can be stored via distributed ledgers and updated at least in part based on media consumption events performed or detected by playback devices, service providers, or other participants. Such distributed data can also be accessed to facilitate playback of media content for particular users, devices, households, or environments.

However, none of the aforementioned earlier-filed applications/patents, individually or in combination, disclose the particular combinations of features and functions shown, described, and claimed herein that relate to (i) playback devices and systems configured to transition between playing back first audio content and handling second audio content associated with a telecommunications session hosted on an external computing device, (ii) playback devices configured to provide an enhanced desktop environment experience, and/or (iii) associated methods of operating such playback devices and systems.

Each of U.S. Pat. Nos. 8,234,395, 8,483,853, 8,788,080, 8,938,312, 9,084,058, 9,094,706, 9,665,339, 9,736,610, 9,973,851, 10,499,146, 10,656,902, 10,712,997, 11,356,777, 11,393,478, 11,483,670, and 11,985,376, U.S. Patent Publication No. 2022/0122583, and International Patent Publications WO/2023/225448 and WO/2025/029673 is hereby incorporated herein by reference in its entirety for all purposes.

While some examples described herein may refer to functions performed by given actors such as “users,” “listeners,” and/or other entities, it should be understood that such references are for purposes of explanation only. The claims should not be interpreted to require action by any such example actor unless explicitly required by the language of the claims themselves.

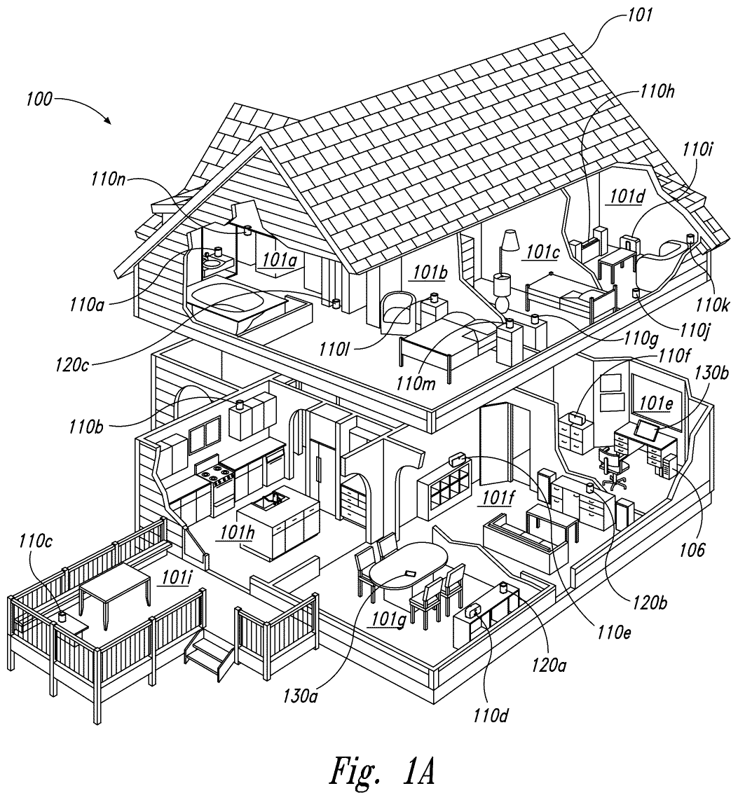

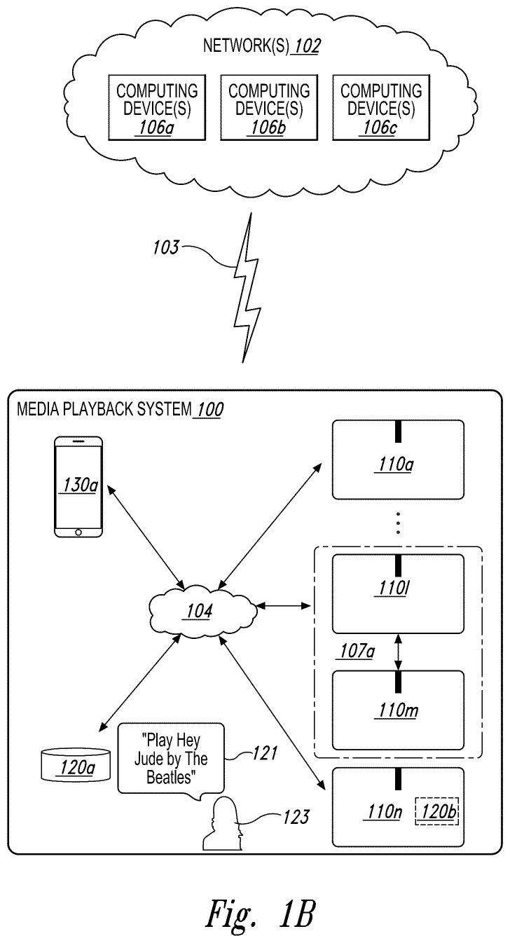

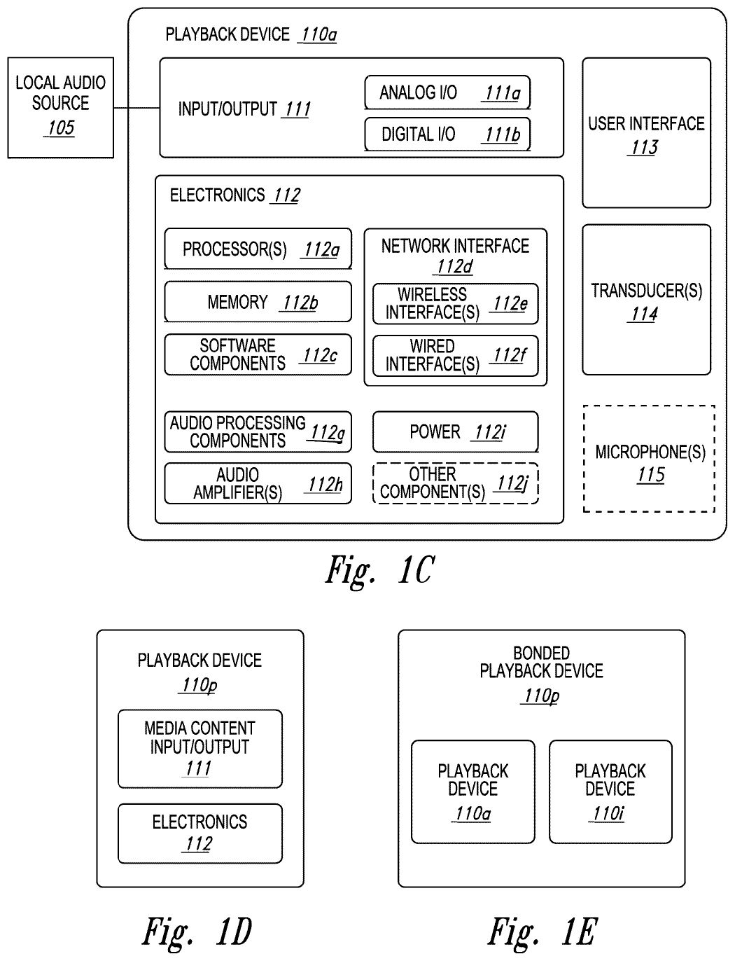

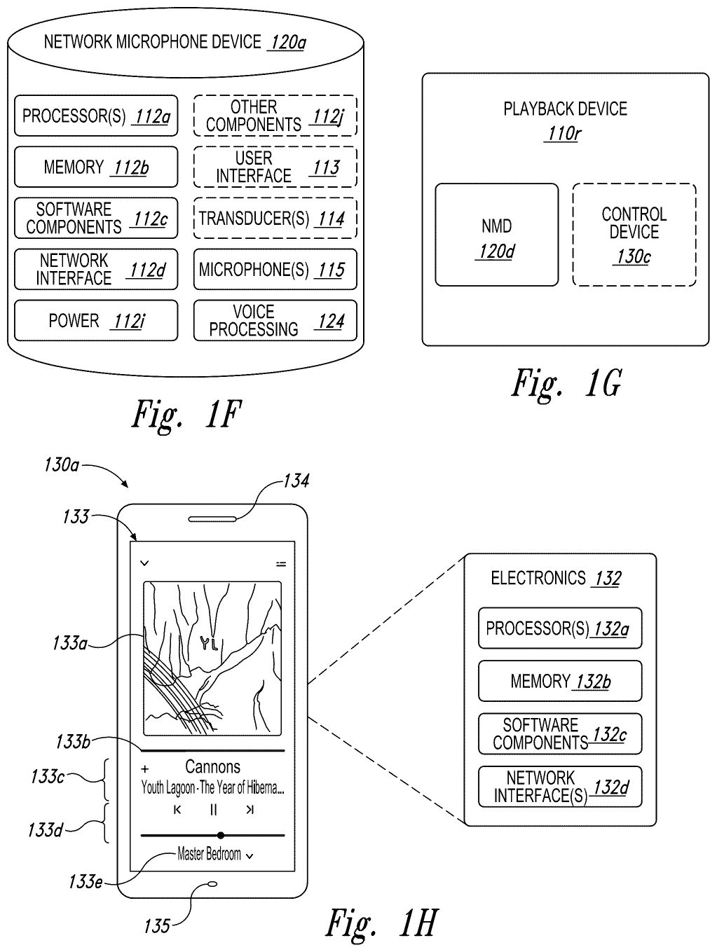

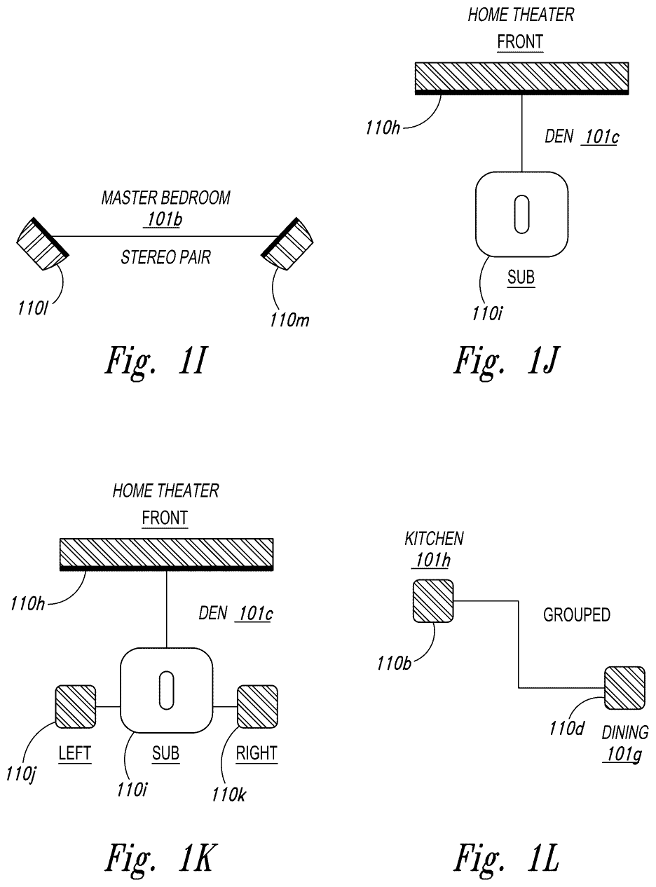

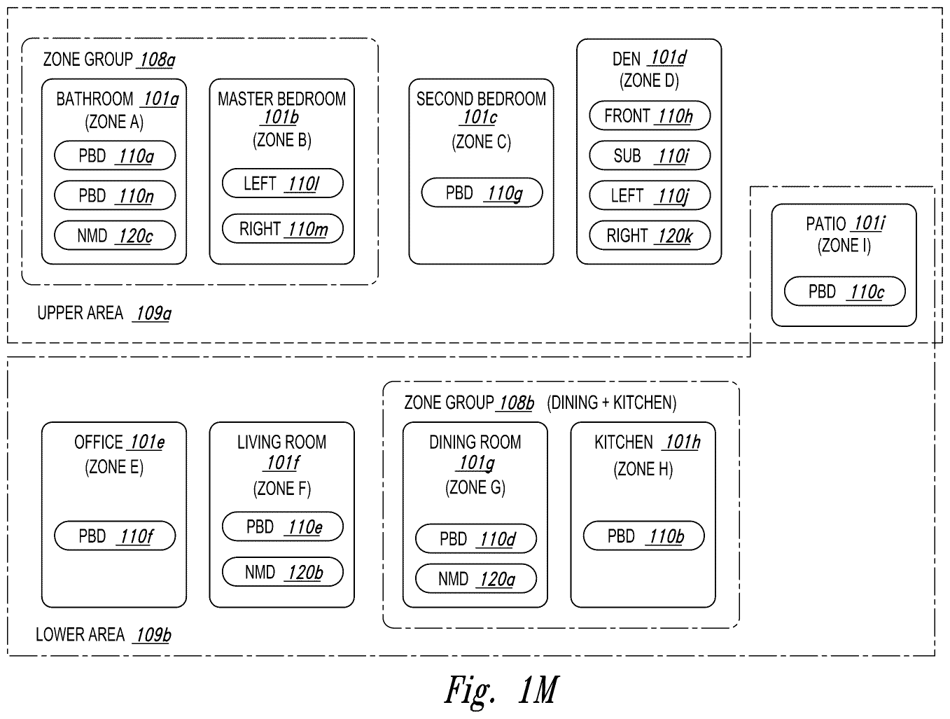

In the Figures, identical reference numbers identify generally similar, and/or identical, elements. To facilitate the discussion of any particular element, the most significant digit or digits of a reference number refers to the FIG. in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa). A playback device with NMD capability may be referred to as an NMD-capable or NMD-enabled playback device.

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices, etc.) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation, etc.). In some embodiments, for example, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the second bedroom 101c, the office 101e, the living room 101f, the dining room 101g, the kitchen 101h, and the outdoor patio 101i each include one playback device 110, and the master bathroom 101a, the master bedroom 101b, and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-k can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B, 1E, and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in Millington '395 referenced above.

a. Suitable Media Playback System

FIG. 1B is a schematic diagram of the media playback system 100 and a cloud network 102. For case of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks), etc. The cloud network 102 is configured to deliver media content (e.g., audio content, video content, photographs, social media content, etc.) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WI-FI network, a BLUETOOTH network, a Z-WAVE network, a ZIGBEE network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WI-FI” can refer to several different communication protocols including, for example, Institute of Electrical and Electronics Engineers (IEEE) 802.11a, 802.11b, 802.11 g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household or commercial facility communication network (e.g., a household or commercial facility WI-FI network). In some embodiments, the links 103 and the network 104 comprise one or more of the same networks. In some aspects, for example, the links 103 and the network 104 comprise a telecommunication network (e.g., an LTE network, a 5G network, etc.). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud servers that host cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length, etc.) and other associated information (e.g., URIs, URLs, etc.) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 11 through 1M.

The media playback system 100 includes the NMDs 120a and 120b, each comprising one or more microphones configured to receive voice utterances from a user. In the illustrated embodiment of FIG. 1B, the NMD 120a is a standalone device and the NMD 120b is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS, AMAZON, GOOGLE, APPLE, MICROSOFT, etc.). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WI-FI, BLUETOOTH, or another suitable communication link. In certain embodiments, the analog I/O 111a and the digital I/O 111b comprise interfaces (e.g., ports, plugs, jacks, etc.) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a BLUETOOTH connection, an ad hoc wired or wireless communication network, and/or another suitable communication link). The local audio source 105 can comprise, for example, a mobile device (e.g., a smartphone, a tablet, a laptop computer, etc.) or another suitable audio component (e.g., a television, a desktop computer, an amplifier, a phonograph (such as an LP turntable), a Blu-ray player, a memory storing digital media files, etc.). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens, etc.), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases, a clock, etc.).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone, etc.).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in Millington '395, which is incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds, etc.) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receive and process the data destined for the playback device 110a.

In the illustrated embodiment of FIG. 1C, the network interface 112d comprises one or more wireless interfaces 112c (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WI-FI, BLUETOOTH, LTE, etc.). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 exclude the network interface 112d altogether and transmit and receive media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DACs), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omit the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers 112h include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 include a single one of the amplifiers 112h configured to output amplified audio signals to a plurality of the transducers 114. In some other embodiments, the electronics 112 omit the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 KHz.

By way of illustration, Sonos, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT: AMP,” “CONNECT,” “AMP,” “PORT,” and “SUB.” Other suitable playback devices may additionally or alternatively be used to implement the playback devices of example embodiments disclosed herein. Additionally, one of ordinary skill in the art will appreciate that a playback device is not limited to the examples described herein or to Sonos product offerings. In some embodiments, for example, one or more playback devices 110 comprise wired or wireless headphones (e.g., over-the-ear headphones, on-ear headphones, in-car earphones, etc.). In other embodiments, one or more of the playback devices 110 comprise a docking station and/or an interface configured to interact with a docking station for personal mobile media playback devices. In certain embodiments, a playback device may be integral to another device or component such as a television, an LP turntable, a lighting fixture, or some other device for indoor or outdoor use. In some embodiments, a playback device omits a user interface and/or one or more transducers. For example, Figure. ID is a block diagram of a playback device 110p comprising the input/output 111 and electronics 112 without the user interface 113 or transducers 114.

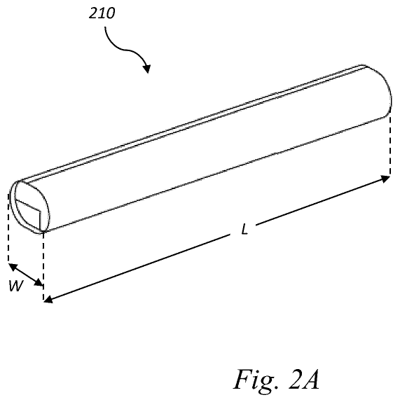

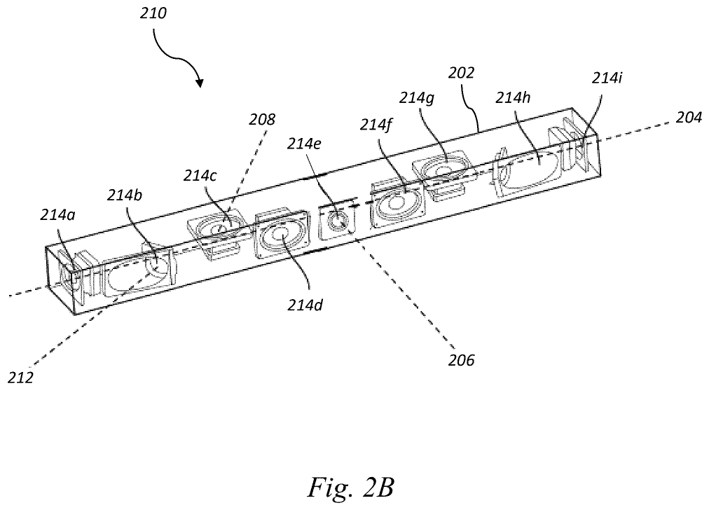

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is a full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-C.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 112h, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers, etc.).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1C) configured to receive user input (e.g., touch input, voice input, etc.) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON VAS, a user might speak the activation word “Alexa.” Other examples include “Ok, Google” for invoking the GOOGLE VAS and “Hey, Siri” for invoking the APPLE VAS.

After detecting the activation word, voice processing components 124 monitor the microphone data for an accompanying user request in the voice input. The user request may include, for example, a command to control a third-party device, such as a thermostat (e.g., NEST thermostat), an illumination device (e.g., a PHILIPS HUE lighting device), or a media playback device (e.g., a SONOS playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

In some instances, a playback device or NMD is capable of running multiple voice assistant services (VAS) client applications (e.g., a VAS wake word detection engine). Activating VAS client applications based on the specific users in the vicinity of the playback device (rather than running all available VAS client applications concurrently) may allow playback devices to operate more efficiently by reducing the computing load of the playback device's processors. Techniques and examples thereof, which may improve functionality of playback devices by, among other advantages, enabling playback devices to seamlessly accommodate a variety of users, each having their own preferred VAS (or VASes) and media source (or media sources) in a variety of environments, are described in Bates '478 referenced above.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™. Android phone, etc.) on which media playback system controller application software is installed. In some embodiments, the control device 130a comprises, for example, a tablet (e.g., an iPad™), a computer (e.g., a laptop computer, a desktop computer, etc.), and/or another suitable device (e.g., a television, an automobile audio head unit, an IoT device, etc.). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 132b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11 g, 802.11n, 802.11ac, 802.15, 4G, LTE, etc.). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection, etc.) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups is presented below with respect to FIGS. 1I through IM.

The user interface 133 is configured to receive user input and can facilitate control of the media playback system 100. The user interface 133 includes media content art 133a (e.g., album art, lyrics, videos, etc.), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year, etc.) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™ an Android phone, etc.). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound, etc.) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones.

c. Suitable Playback Device Configurations

FIGS. 1I through IM show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110b and 110d can be merged to form a merged group or a zone group 108b. The merged playback devices 110b and 110d may not be specifically assigned different playback responsibilities. That is, the merged playback devices 110b and 110d may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1I, the playback devices 110l and 110m may be bonded so as to produce or enhance a stereo effect of audio content. In this example, the playback device 110l may be configured to play a left channel audio component, while the playback device 110m may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1K shows the Front and SUB devices 110h and 110i further bonded with Left and Right playback devices 110j and 110k, respectively. In some implementations, the Left and Right devices 110j and 110k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in Lang '146 referenced above.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in Millington '395 referenced above. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variable instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (Figure. IL). Identifiers associated with the Kitchen may indicate the same or similar information by virtue of the Kitchen being part of the Dining+Kitchen zone group 108b. Other example zone variables and identifiers are described below.

In yet another example, the memory may store variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D and I, and a Lower Arca 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in Wilberding '997 and Lambourne '853, both of which are incorporated herein by reference above. In some embodiments, the media playback system 100 may not implement Areas, in which case the system may not store variables associated with Areas.

### III. Example Playback Devices

FIG. 2A is a perspective view of one example of a desktop playback device 210 configured in accordance with aspects of the disclosed technology. FIG. 2B illustrates an example of the desktop playback device 210, with a housing 202 drawn transparently to illustrate a plurality of transducers 214a-i therein (collectively “transducers 214”). The desktop playback device 210 may further comprise various other components housed within, or partially within, the housing 202 but not illustrated in FIG. 2B, including, for example, the electronics 112, user interface 113, microphone(s) 115, and input/output 111 (FIG. 1C). In these examples, some or all of the other components within the housing 202 may be coupled to and operate with the transducers 214 or in place of the transducers 114. As described further below, according to certain examples, the desktop playback device can be configured to transition between playing back first audio content (e.g., music or other audio) and handling second audio content that is associated with a telecommunications session hosted on an external computing device to which the desktop playback device is coupled. Accordingly, the desktop playback device can include components and functionality (e.g., at least partially implemented using the processor(s) 112a and software components 112c) that are configured to facilitate such transitions in a seamless and rapid manner and thereby offer an enhanced user experience. Furthermore, the desktop playback device may include transducer arrangements and driver configurations for the transducers that can be configured to (i) leverage a likely position of a user close to the desktop playback device, and/or (ii) enhance speech quality when playing back the second audio content.

As described above, the electronics 112 are configured to receive audio content from an audio source and send electrical signals corresponding to the audio content to transducers (e.g., the transducers 214) for playback. Accordingly, the transducers 214 are configured to receive the electrical signals from the electronics 112, and further configured to convert the received electrical signals into audible sound during playback. For instance, the transducers 214 can include one or more tweeters that can be configured to output high frequency sound (e.g., sound waves having a frequency greater than about 2 kHz). The transducers 214 may further include one or more mid-woofers, woofers, or midrange speakers that can be configured output sound at frequencies lower than the tweeter(s) (e.g., sound waves having a frequency lower than about 2 kHz). Each transducer 314 may include one or more audio drivers to drive the respective transducer to produce acoustic output in accord with various driver parameters (e.g., amplitude, equalization, filtering, etc.). Furthermore, in some examples, each transducer 214 may be driven by an individual corresponding audio amplifier of the audio amplifier(s) 112h.

In the example of the desktop playback device 210 illustrated in FIGS. 2A and 2B, the housing 202 has an elongated form factor. Thus, the housing 202 is elongated along a first lateral (e.g., horizontal) axis 204, and the desktop playback device 210 is configured to face along a second lateral axis 206 that is substantially orthogonal to the first lateral axis 202. The second lateral axis 206 is also referred to as a forward axis and may be a primary sound axis of the desktop playback device 210, as described further below. The housing 202 has a length, L, that may be measured along the first lateral axis 202 and a width, W, that may be measured along the second lateral axis 206.

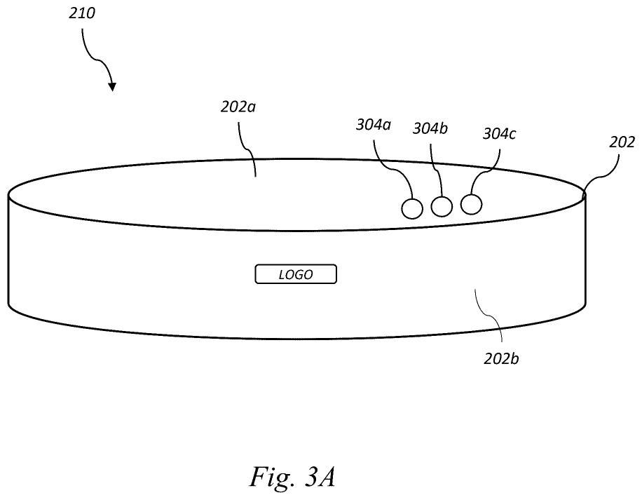

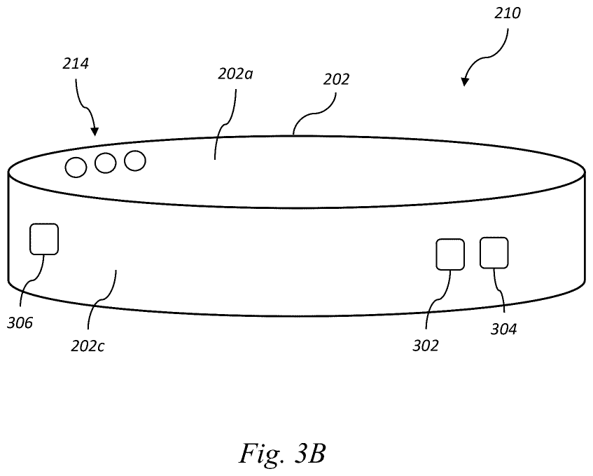

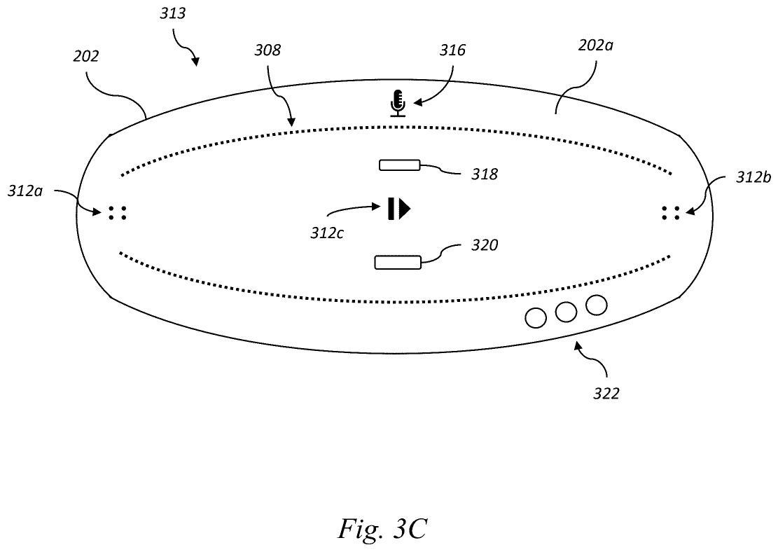

Examples of the desktop playback device 210 may have various different form factors, not limited to any specific shape illustrated herein. For example, the housing 202 may have a semi-cylindrical shape, as illustrated in FIG. 2A. In other examples, the housing 202 may have a substantially rectangular shape, as illustrated in FIG. 2B, or a semi-oval shape, as illustrated in FIGS. 3A-C, for example. The housing 202 can be implemented having numerous other shapes, with or without an elongated form factor. Furthermore, in some examples, the desktop playback device 210 may be integrated with another device, such as a monitor or projector (e.g., an ultra short-throw projector). As such, the housing 202 of the playback device may be part of (or common with) the housing of the other device. In further examples, the housing 202 of the desktop playback device 210 may be shaped and configured to attach to another device, such as a monitor for example. The housing 202 may be configured to attach to the top, bottom, and/or sides of a monitor or other display device, for example.

Referring to FIG. 2B, in some examples, the desktop playback device 210 can include individual transducers 214a-i oriented in different directions or otherwise configured to direct sound along different sound axes. For example, the desktop playback device may include one or more forward-firing transducers, such as the transducers 214d-f, that are configured to direct sound primarily along directions parallel to the second lateral axis 206 of the playback device 210. In some examples, the forward-firing transducer(s) may be configured to direct sound along one or more forward sound axes that are inclined or vertically angled relative to the plane of the forward axis 206 by an inclination angle that is less than 30 degrees. Additionally, the desktop playback device 210 can include one or more up-firing transducers (e.g., transducers 214c and 214g) that are configured to direct sound along axes that are angled vertically with respect to the lateral sound axes 204, 206. For example, the left up-firing transducer 214c is configured to direct sound along a vertical axis 208, which is vertically angled with respect to the first and second lateral axes 204, 206. In some examples, the vertical axis 208 can be angled with respect to the second lateral axis 206 by between about 50 degrees and about 90 degrees, between about 60 degrees and about 80 degrees, or about 70 degrees.

The desktop playback device 210 can optionally include one or more side-firing transducers (e.g., transducers 214a, 214b, 214h, and 214i), which can direct sound along axes that are horizontally angled with respect to the first and second lateral axes 204, 206. In the illustrated example, the outermost transducers 214a and 214i can be configured to direct sound primarily along the first lateral axis 204 or at least partially horizontally angled therefrom, while the side-firing transducers 214b and 214h are configured to direct sound along an axis that lies between the first and second lateral axes 204, 206. For example, the left side-firing transducer 214b is configured to direct sound along an axis 212 in the example illustrated in FIG. 2B. In some examples, the sound axes along which the side-firing transducers direct sound (side sound axes) are parallel with the first or second lateral axes 204, 206. In other examples, any one or more side sound axes can be vertically angled with respect to the first and second lateral axes by the same or different inclination angles, any of which may be, for example, up to 10, 20, 30, or 40 degrees in some examples.

In other examples, the desktop playback device 210 can assume other forms, for example having more or fewer transducers 214, having other form-factors, or having any other suitable modifications with respect to the examples shown in FIGS. 2A and 2B. For example, the desktop playback device 210 may include fewer than nine transducers (e.g., one, two, three, etc.). In some examples, the desktop playback device 210 may omit some or all of the side-firing and/or up-firing transducers. In some examples, the transducers 214 include a set of one or more transducers that are used to play back audio content generally (e.g., the first audio content) and one or more other transducers that are dedicated to playing back the second audio content during a telecommunications session. Furthermore, the transducers 214 may be arranged differently than shown in FIG. 3B. In some examples, all or some of the transducers 214 are configured to operate as a phased array to desirably adjust (e.g., narrow or widen) a radiation pattern of the transducers 214, thereby altering a user's perception of the sound emitted from the playback device 210. In some examples in which the desktop playback device 210 does not have some or all of the side-firing transducers 214a, 214b, 214h, 214i, for example, side-propagating audio can be achieved by use of arrays, in which the audio output by each transducer 214 sums such that the combined output has a directivity and is oriented along a side-propagating axis. In some examples, the desktop playback device can be used to play back audio content that includes a vertical component (also referred to herein as a “height component”). For example, certain 3D audio or other immersive audio formats include one or more height audio channels in addition to any lateral (e.g., left, right, front) audio channels. Examples of such 3D audio formats include DOLBY ATMOS, MPEG-H, and DTS: X formats, for example. In other examples, the desktop playback device 210 can be configured to use a vertical audio channel, and/or one or more up-firing transducers, to provide a spatial component to certain information conveyed to a user, as described in more detail below. In examples of the desktop playback device that do not have up-firing transducers, upward-propagating audio can be achieved by use of arrays, in which the audio output by each transducer sums in a manner that the combined output has a directivity and is oriented along a vertical axis.

According to certain examples, the desktop playback device 210 can be configured to control the transducers 214 to produce different radiation patterns depending on whether the desktop playback device is playing back the first audio content or the second audio content. For example, the desktop playback device can be configured to play back the first audio content via the plurality of audio transducers 214 according to a first radiation pattern, and to play back the second audio content via the plurality of audio transducers 214 according to a second radiation pattern. In some examples, the second radiation pattern is narrower than the first radiation pattern. For example, if the first audio content is music, optionally including multi-channel content, the listening experience may be enhanced by configuring the transducers 214 to produce a wider radiation pattern and thereby widen a perceived sound field of the audio, which may lead to a more immersive listening experience for the user.

For example, Chamness '851 describes controlling the audio drivers associated with various transducers of a playback device to balance the directional effect of the sound field produced by the playback device. Chamness '851 describes that, in order to widen an area over which a balanced directional effect may be perceivable, signal processing may be used to produce first and second target radiation patterns corresponding respectively to first and second sets of audio drivers/transducers. For example, at a given frequency, boosting (or attenuating) a magnitude of, and/or adding a phase shift to, an input signal provided to a particular audio driver may help compensate for the particular transducer being relatively quiet (or relatively loud) along a given listening direction. Chamness '851 discloses various techniques that may be employed by the desktop playback device 210 to produce particular radiation patterns and corresponding sound fields in different circumstances.

In addition, Chamness '610 referenced above describes adjusting radiation patterns corresponding to particular audio channels of multi-channel audio content to selectively widen or narrow the resulting sound field. For example, Chamness '610 discloses that the playback device can provide a center channel of the audio content to multiple groups of audio drivers/transducers, such as a first group, a second group, and a third group, for example. The first, second, and/or third groups may generate sound waves corresponding to the center channel according to a first radiation pattern having a maximum along a first direction (e.g., along the second lateral axis 206). The playback device may also provide a first side channel to the first group so that the first group may generate sound waves corresponding to the first side channel according to a second radiation pattern having a maximum along a second direction (e.g., along the first lateral axis 204). The first radiation pattern and the second radiation pattern may combine via superposition to form a first response lobe that has a maximum along a third direction between the first and second directions. Since the first radiation pattern represents the center channel and the second radiation pattern represents the center channel and the first side channel, the first response lobe represents playback of both the center channel and the first side channel with a perceived wideness that is dependent on the relative input amplitudes of the center channel and the first side channel. That is, by increasing the amplitude of the center channel with respect to the first side channel, the maximum of the first response lobe is shifted toward the first direction, resulting in a “narrowed” multi-channel audio “image.” Similarly, by decreasing the amplitude of the center channel with respect to the first side channel, the maximum of the first response lobe is shifted toward the second direction, resulting in a “widened” multi-channel audio “image.” These and other techniques disclosed in Chamness '610 can be implemented by the desktop playback device 210 to produce a desired sound field in different circumstances, as described below.

Furthermore, in some examples, the desktop playback device 210 can be configured to adjust the sound field based on the user's position relative to the desktop playback device. This may be particularly useful when the desktop playback device is playing back the second audio content (e.g., including speech). For example, by directing the overall radiation pattern produced by the transducers 214 in a direction substantially aligned with a user's head, the user may more clearly perceive/hear the speech. Accordingly, in some examples, the desktop playback device 210 can be configured to adjust the radiation pattern of the transducers so as to align a direction along which the radiation pattern has a maximum amplitude with a determined direction of the user's head. For example, the desktop playback device can be configured to determine, using one or more sensors of the desktop playback device (e.g., as may be included in the components 112j), a position of the user's head aligned with a particular direction with respect to the desktop playback device. The radiation pattern can then be adjusted to align the direction of maximum amplitude with the direction of the user's head. For example, Reily '058 referenced above discloses techniques for triangulating the position of a listener using one or more location sensors and adjusting the sound field accordingly that can be implemented by examples of the desktop playback device 210. In some examples, the transducers 214 can be configured to produce a sound field tailored for a near-field acoustic region of the desktop playback device 210. In some examples, the near-field acoustic region of the desktop playback device extends up to 6 feet from a front of the desktop playback device.

FIGS. 3A and 3B are front and back isometric side views, respectively, of an example of the desktop playback device 210 configured in accordance with embodiments of the disclosed technology. FIG. 3C is a top view of an example of the desktop playback device 210, illustrating a user interface 313 (e.g., an example of the user interface 113 described above) of the desktop playback device. In some examples, the housing 202 includes an upper (or top) portion 202a and one or more side portions, such as a front side portion 202b (shown in FIG. 3A) and a rear (or back) side portion 202c (shown in FIG. 3B). The housing 202 may further include a lower (or bottom) portion (not shown).

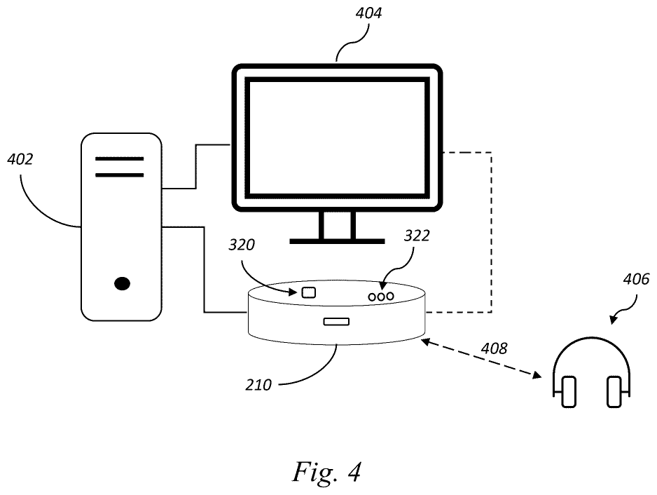

As described above, according to certain examples, the desktop playback device 210 is configured to be coupled to an external computing device 402, as illustrated in FIG. 4, for example. Accordingly, the desktop playback device 210 may include a first communication interface for coupling to the external computing device and receiving audio content and optionally other data/information from the external computing device 402. In some examples, connection to the external computing device 402 is achieved using a wired communication interface (e.g., a wired interface 112f described above). In some examples, using a wired connection between the desktop playback device 210 and the external computing device 402 may reduce latency between media playback on the external computing device 402 and the corresponding audio output on the desktop playback device 210. Accordingly, referring to FIG. 3B, in some examples, the desktop playback device 210 includes a connection port 302 for connecting to the external computing device 402. The connection port 302 may include a port suitable for coupling to an audio line-in connector and/or cable, and/or other data transfer cable. For example, the connection port 302 may include a USB-A, USB-C, HDMI, and/or Thunderbolt port, for example. The connection port 302 may be part of or coupled to the first communication interface (e.g., one of the wired interface(s) 112f).

Still referring to FIG. 3B, according to certain examples, the desktop playback device 210 further includes a power connection 304, such as a port and/or cable suitable for connecting the desktop playback device 210 to a power source (such as AC mains power, for example). In other examples, the desktop playback device may be a battery operated device, or may receive operating power via a charging base, and thus may omit the power connection 304. The desktop playback device 210 may further include one or more additional power and/or data ports 306. In some examples, the desktop playback device 210 may be configured to act as a “hub” (e.g., a powered or non-powered USB hub) for various devices that may be coupled to the external computing device (e.g., one or more display devices, printers, user interface devices, such as a keyboard or mouse, etc.).

For example, as shown in FIG. 4, the external computing device 402 may be coupled to a display 404. In some examples, the display 404 can be coupled to the external computing device 402 via the desktop playback device 210 (e.g., via an additional port 306). The desktop playback device 210 may be further configured to supply power to certain devices, such as a mobile phone, for example. Accordingly, the one or more additional power and/or data ports 306 may provide connection capability for such devices. For example, the one or more other power and/or data ports 306 may include ports such as one or more USB (e.g., USB-A and/or USB-C) ports, one or more ethernet ports, one or more HDMI ports, etc. In the illustrated example of FIG. 4, the desktop playback device 210 is coupled to the external computing device 402 and the display 404. In other examples, however, the external computing device 402 may comprise a projector and the display 404 is not a device, but rather a projected image on a surface (e.g., a wall or a dedicated screen). In certain examples, the external computing device 402 projects an extended reality scene that is projected or overlaid onto a wall or screen. Torgerson '670 referenced above describes, for instance, overlaying a virtual scene onto a user's environment and outputting audio based on a position of an audio playback device (e.g., the desktop playback device 210) and/or the user. In some examples, the desktop playback device 210 comprises a video output and/or suitable computing capacity, obviating a need for a separate external computing device 402 such that the desktop playback device 210 itself outputs video, either via the display 404 or a projected image (or perhaps both).

Referring again to FIG. 3B, the connection port 302, the power connection 304, and the additional power and/or data port(s) 306 are shown located on the rear portion 202c of the housing 202. However, in other examples, any one or more of these ports/connections may be located on other portions of the housing 202, such as the front portion 202b, other side portions (not illustrated), the top portion 202a, or the bottom portion (not illustrated). Furthermore, the connection port 302, the power connection 304, and/or the additional power and/or data port(s) 306 may be arranged differently than illustrated in FIG. 3B.

According to certain examples, the desktop playback device 210 includes the user interface 313 (which, as noted above, may be an example of the user interface 113) to allow a user to interact with the desktop playback device 210 and to control various functionality of the desktop playback device 210. In some examples, the user interface 313 is disposed on the top portion 202a of the housing 202, as illustrated in FIG. 3C, for example. However, in other examples, any one or more features of the user interface 313 may be disposed on any one or more other portions (e.g., the front portion 202b) of the housing 202.

As described above, the desktop playback device can be configured to handle, and to transition between, different types of audio content from multiple different sources. In a first mode of operation, the desktop playback device 210 may play back first audio content via the transducers 214. The first audio content may be music, for example, and may be received by the desktop playback device 210 via a second communication interface, such as one of the wireless interface(s) 112e, for example. In other examples, the first audio content may be received from the external computing device 402 (e.g., from a music or other audio library stored on one or more computer-readable storage media part of or accessible to the external computing device 402). For example, Reily '706 referenced above describes an interface between a computing device and playback device that provides communication between the devices. The first audio content may be received and played back by the desktop playback device 210 as described above with reference to FIGS. 1A-H. Accordingly, referring to FIG. 3C, the user interface 113 may include one or more controls that allow a user to control various aspects of playback of the first audio content, such as to skip or repeat playback of certain songs or tracks, or to begin, pause, or stop playback. In some examples, the user interface 313 includes a plurality of control surfaces (e.g., buttons, knobs, capacitive surfaces) including a first control surface 312a (e.g., a previous control), a second control surface 312b (e.g., a next control), and a third control surface 312c (e.g., a play and/or pause control) that can be adjusted by a user to control playback of audio content via the transducers 214 of the desktop playback device 210. The user interface 313 may include various other control surfaces (not illustrated in FIG. 3B) that allow the user to control various aspects of playback of audio content via the desktop playback device 210. Examples of such controls are described in Kotelly '902 referenced above.

As also described above, the desktop playback device 210 can be configured to handle second audio content that is associated with a telecommunications session (e.g., an online meeting) hosted by the external computing device 402. In some examples, to handle the second audio content includes to play back the second audio content via the transducers 214, as described further below. In other examples, to handle the second audio content includes to transfer the second audio content to another playback device, such as a wearable playback device 406, as also described further below. In some examples, the telecommunications session may include two-way communication, meaning that a user may both provide audio input to the telecommunications session and listen to the second audio content from other participants in the telecommunications session. Accordingly, in some examples, the desktop playback device 210 includes one or more microphones 115 described above in FIG. 1C. Examples of using a playback device in combination with a computing system for two-way audiovisual communications sessions are described, for example, in Bates '2583 referenced above.

In some examples, the desktop playback device 210 outputs generative audio, which can comprise novel, synthetic audio created by one or more generative AI models or another suitable content model/source. In certain examples, the generative audio comprises a combination of pre-existing audio and synthetic audio. As described in further detail in Wilberding '376, the generative AI model may be stored on the desktop playback device 210 itself, a local hub device (e.g., another playback device on the same network as the desktop playback device 210), and/or one or more remote computing devices (e.g., one or more of the computing devices 106 of FIG. 1B). In many examples, the generative audio is generated or created based on one or more input parameters.

In some examples, for instance, the generative audio (or other generative AI content) is generated or created based on data stored on a distributed ledger, such as a blockchain. Wilberding '448, for instance, describes input parameters (e.g., playback device state and/or characteristics) that are stored via one or more distributed ledgers and/or blockchains. Butts '673 also describes storing content experience record sets (CERS) and content network record sets (CNRS) on a distributed ledger that may comprise nodes, for instance, on a local private playback network. Butts '673 discloses, for instance, generating output and/or predicting user/device settings via a generative AI model(s) based on CERS and/or CNRS data stored on a distributed ledger. In this way, the system can provide, among other things, personalized media experiences based on user contextual data and/or consumption history. For example, the desktop playback device 210 can generate unique background music during a telecommunications session based on a user's preferred genres and past listening habits, or create adaptive sound environments for focus or relaxation, with the parameters for generation being drawn from, and potentially recorded back to, a distributed ledger. In certain examples, metadata about generated content, such as creation parameters of the content or licensing information, may also be recorded on the distributed ledger as described by both Wilberding '448 and Butts '673. Such recordations can facilitate data transparency and user control over the provenance and usage rights of the generated audio. In some examples, one or more tasks associated with generative content creation and/or control of the media playback system is performed or facilitated by one or more AI agents, as also described by both Wilberding '448 and Butts '673.

In some examples, the desktop playback device 210 can leverage the CERS and/or CNRS stored on a distributed ledger to access a comprehensive, cross-platform history of the user's media consumption, not just limited to the current media playback system. For example, if the user frequently listens to specific podcasts on a mobile device (data that could be recorded on the CERS via the mobile device), the desktop playback device may proactively suggest new episodes or similar podcasts, or even generate short audio summaries of recent episodes, tailored to the user's documented preferences.

In some examples, one or more generative AI models can be used to create spatial audio cues or notifications that are personalized and context-aware. For instance, based on a user's calendar events (accessible perhaps via a distributed ledger if configured for privacy-preserving access), the device can generate a unique, non-disruptive audio notification that subtly shifts in its perceived origin point around the user to indicate an upcoming meeting or a new message, using, for instance, phased array capabilities (as described above) for directional sound. The style and urgency of these generated audio cues can be influenced by the user's emotional state or activity level, as inferred from other sensors and stored on the distributed ledger.

Referring again to FIG. 3C, in examples in which the desktop playback device 210 includes one or more microphones 115, the desktop playback device 210 further includes a plurality of ports, holes or apertures 308 in the upper portion 202a to allow sound to pass through to the one or more microphones 115 positioned within the housing 202. The one or more microphones 115 are configured to receive sound via the apertures 308 and produce electrical signals based on the received sound. In some such examples, the desktop playback device 210 may be an NMD-enabled playback device (e.g., incorporating at least some NMD functionality described above).

In some examples, the user interface 313 further includes a microphone indicator 316. In some examples, the microphone indicator 316 is a control surface configured to receive touch input corresponding to activation and deactivation of the one or more microphones 115. In some examples, the microphone indicator 316 may include an indicator such as one or more light emitting diodes (LEDs) or another suitable illuminators that can be configured to convey microphone status information. For example, the illuminator(s) may be configured to illuminate the microphone indicator 316 only when the one or more microphones 115 are activated. In another examples, the illuminator(s) can be configured to change an illumination color of the microphone indicator 316 depending on the status of the microphones 115. For example, the microphone indicator 316 may be illuminated in a first color (e.g., green) when the microphones 115 are active and in a second color (e.g., red) when the microphones 115 are deactivated or “muted.” In another example, the illuminator(s) of the microphone indicator 316 can be configured to remain solid to indicate that the microphones 115 are on and to blink or otherwise change from solid to indicate a detection of voice activity. In some examples, the microphone indicator 316 includes both the microphone control surface and the illuminator(s). In other examples, the microphone indicator 316 may include the microphone control surface, for example, and one or more separate illuminators can be provided to indicate microphone status and/or activity.

According to certain examples, the user interface 313 further includes a status indicator 318 that can be configured to convey information regarding, and/or allow control of, a status of the desktop playback device 210. In some examples, the status indicator 318 indicates a power status of the desktop playback device 210 (e.g., whether or not the desktop playback device 210 is turned on or off). In some examples, the status indicator 318 includes a control surface (e.g., a power button or switch) that allows the user to turn the desktop playback device on and off. In other examples, a power control surface may be provided separately from the status indicator 318 and optionally on a different portion of the housing 202 (e.g., on the rear portion 202b of the housing). The status indicator 318 may include one or more illuminators (e.g., LEDs or other light sources) that are configured to illuminate, and/or change illumination color, and/or change illumination format (e.g., solid or blinking) based on the status of the desktop playback device. In some examples, the status indicator 318 can be used to indicate one or more other statuses of the desktop playback device in addition to, or instead of, a power status, such as, for example, a mode of operation, WI-FI connectivity, BLUETOOTH connectivity, etc. Accordingly, the status indicator 318 may include two or more individual indicators in some examples.

As described above, the desktop playback device 210 can be configured to allow for rapid, easy transition between playback of first audio content (e.g., music, spoken word content) and handling of second audio content associated with a telecommunications session hosted on the external computing device 402. Accordingly, to facilitate such transition, in some examples, the user interface 313 includes a transition element 320. In some examples, the transition element 320 is implemented as a control surface, similar to the control surfaces 312a-c described above. In some examples, when the desktop playback device 210 is playing back the first audio content, actuating the transition element 320 causes playback of the first audio content to cease. Causing playback of the first audio content to cease may also be accomplished by actuating the third (e.g., play/pause) control surface 312c. However, the transition element 320 may offer functionality not provided by the third control surface 312c. For example, actuating the third control surface 312c may cause the desktop playback device 210 to cease playback of any/all audio content. In contrast, actuating the transition element 320 causes the desktop playback device 210 to transition from a first mode of operation, in which the first audio content is played back via the transducers 214, to a second mode of operation. This transition may or may not cause playback of the first audio content to cease. Rather, in the second mode of operation, the desktop playback device 210 can be configured to handle both the first audio content and the second audio content in a variety of different ways, as described in more detail below.

In some examples, transitioning to the second mode of operation includes ceasing to play back the first audio content and begin playing back the second audio content via the transducers 214. In other examples, transitioning to the second mode of operation includes altering one or more playback parameters of the first audio content, while also handling the second audio content. To alter one or more playback parameters of the first audio content may include actions such as reducing a volume of playback of the first audio content via the transducers 214, or changing a source and/or type of the first audio content (e.g., switching from playing back a certain genre or playlist to playing back a different genre or playlist), for example. Thus, actuating the transition element 320 does not necessarily cause the desktop playback device to cease playback of the first audio content. In further examples, actuating the transition element 320 may cause the desktop playback device 210 to transition playback of the first audio content (optionally with one or more parameters, such as volume, source, type, etc., modified) to another playback device, while the desktop playback device 210 begins to play back the second audio content. In other examples, actuating the transition element 320 may cause the desktop playback device to cease or alter playback of the first audio content and to cause another playback device (e.g., the wearable playback device 406) to play back the second audio content. Various examples of transitioning the desktop playback device from one more of operation to another (based on a transition trigger that may or may not come from the transition element) are described in more detail below.

Still referring to FIG. 3C, in some examples, the desktop playback device 210 includes one or more contact access controls 322. The access controls 322 may include control surfaces and/or indicators (such as LEDs or other illuminators). Individual contact access controls 322a, 322b, 322c (FIG. 3A) may be assigned to different individuals (user contacts) associated with the user of the desktop playback device. In some examples, the individual contact access controls 322a, 322b, 322c, are assigned to user contacts with whom the user has frequent interaction. Assigning the individual contact access controls 322a, 322b, 322c to respective user contacts may be performed via a control device 130 or via the external computing device 402, for example. The contact access controls 322 can be configured to facilitate establishing telecommunications sessions with respective user contacts. For example, actuating a control surface associated with an individual contact access control may cause the electronics 112 to communicate, for example via an application programming interface (API), one or more messages to a service hosted by the external computing device 402 or another computing device. The service may be a telecommunications/meeting service, such as a MICROSOFT TEAMS service, a ZOOM service, or the like. The messages may specify a request to attempt to establish a telecommunications session with the assigned user contact and a telecommunications session type (e.g., audio only, audio and video, etc.). In some examples, the individual contact access controls 322a-c may indicate an availability of the respective assigned user contacts for engaging in telecommunications sessions. For example, an individual contact access control 322a, 322b, or 322c, may be illuminated in one color (e.g., green) if the assigned user contact is available for a telecommunications session and in another color (e.g., red) if the assigned user contact is unavailable (e.g., busy or offline). In some examples, user contact status information may be acquired by the desktop playback device 210 from the external computing device 402 or the other computing device via the API exposed and implemented by the service. In certain examples, user contact status information may be acquired via information stored on a blockchain as described, for instance, in Wilberding '448. In the examples illustrated in FIGS. 3A-3C, three individual contact access controls 322a, 322b, 322c are shown. However, in other examples, the user interface 313 may include more or fewer than three contact access controls 322.

In some embodiments, the user interface 313 includes additional or fewer control surfaces, indicators, and/or illuminators, than those illustrated in FIG. 3C. In addition, any of the elements/components of the user interface 313 may be arranged differently than shown in FIG. 3C and/or may be located on a portion of the housing 202 other than the top portion 202a.

Referring again to FIG. 4, as described above, in certain instances, handling or processing of the second audio content by the desktop playback device 210 includes causing another playback device to play back the second audio content. For example, the desktop playback device 210 may transfer the second audio content to the wearable playback device 406 for playback. In some examples, the desktop playback device 210 communicates with the wearable playback device 406 via one of the wireless interface(s) 112e and a wireless communication link 408. Examples of transitioning playback of audio content from one playback device to another are described in Wilberding '777 referenced above.

According to certain examples, the desktop playback device can also be configured to transfer other audio content to the wearable playback device 406 (e.g., via the wireless communication link 408) or another playback device. As described above, the desktop playback device 210 can include a plurality of network interfaces 112, including the first communication interface for communicating with the external computing device 402 (e.g., one of the wired interfaces 112f) and the second communication interface (e.g., one of the wireless interfaces 112c) for communicating with other playback device(s) and optionally for receiving the first audio content. In some examples, the desktop playback device 210 may further include a third communication interface (e.g., a wireless interface 112e) via which the desktop playback device may receive third audio content. For example, the desktop playback device 210 may receive audio from elsewhere in the environment 101, such as from an intercom, doorbell, or other device. In some examples, the desktop playback device 210 may play back this third audio content via its transducers 214. In other examples, the desktop playback device 210 may cause, via the second communication interface and the wireless communication link 408, for example, playback of the third audio content by another playback device, such as the wearable playback device 406, for example.

In some examples, the desktop playback device 210 transitions other content in addition to audio content. In scenarios, for instance, in which the wearable playback device 406 comprises an extended reality device (e.g., a virtual reality device, an augmented reality device, and/or a mixed reality device), the desktop playback device 210 may also provide and/or facilitate visual content playback (e.g., text, image, video) via the wearable playback device 406 in addition to (or perhaps exclusive of) audio content. In some instances, the desktop playback device 210 transitions extended reality output from an “out-loud” basis (e.g., displayed via the display 404 or projected onto the wall) as described in Torgerson '670 to a “close-in” mode (e.g., displayed via the wearable device 406). In certain examples, the visual content may comprise AI-generated, synthetic visual content such as generative media content described in Wilberding '376 referenced above.

### IV. Example Methodology

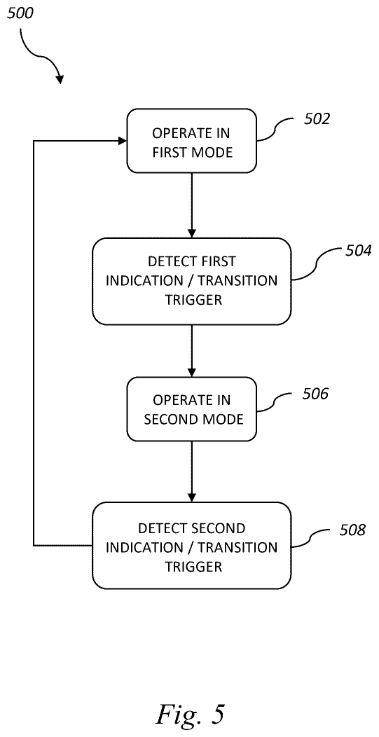

FIG. 5 is a flow diagram of one example of a method 500 of operating a playback device, such as the desktop playback device 210, for example, to transition between different modes of operation. As described above, in some examples, transitioning from a first mode of operation to a second mode of operation allows the desktop playback device to seamlessly handle incoming audio content associated with telecommunication sessions, thereby potentially reducing user anxiety that may be associated with receiving an incoming telecommunications session when the user is listening to other audio content. In some examples, the desktop playback device can be configured to handle first audio content and/or the incoming second audio content in different ways depending on various factors, such as a source or type of a transition trigger or other notification of the incoming second audio content, identity of one or more participants (other than the user of the desktop playback device) in the telecommunication session, and/or user input associated with the transition, for example. These and other examples and features are further described below.

Referring to FIG. 5, at operation 502, the desktop playback device 210 is operated in a first mode of operation. As described above, operating in the first mode of operation may include playing back, via the transducers 214, first audio content.

While operating in the first mode of operation (e.g., while playing back the first audio content), at operation 504, the desktop playback device detects a first indication of incoming second audio content associated with a telecommunications session hosted on the external computing device 402. In some examples, the first indication is a signal (e.g., a transition trigger) from the transition element 320. In other examples, the first indication includes a signal from the external computing device 402. For example, when a telecommunication session is initiated on the external device 402, the desktop playback device may detect, via its connection to the external computing device, a signal that indicates that the telecommunication session has been initiated. Millington '312 referenced above discloses examples of a playback device detecting a signal via a line-in connection and taking certain actions based thereon. In some examples, the desktop playback device 210 can be configured to implement such techniques disclosed in Millington '312. In another example, the first indication includes a calendar notification from the external computing device 402 indicating that the telecommunications session is scheduled to be initiated on the external computing device 402. In some examples in which the first indication includes a calendar notification, the desktop playback device 210 includes a clock to determine time, and can be configured schedule/take certain actions based on a time-related condition. For example, the calendar notification may include a scheduled time for initiation of the telecommunications session on the external computing device 402, and the desktop playback device can be configured to control (e.g., stop or alter) playback of the first audio content at a time based on the scheduled time. In another example, the first indication includes an API message received from a service hosted by the external computing device 402 or another computing device. In this example, a process running on the desktop playback device may register with the service to receive indications of requested and/or scheduled telecommunication sessions that have been initiated.

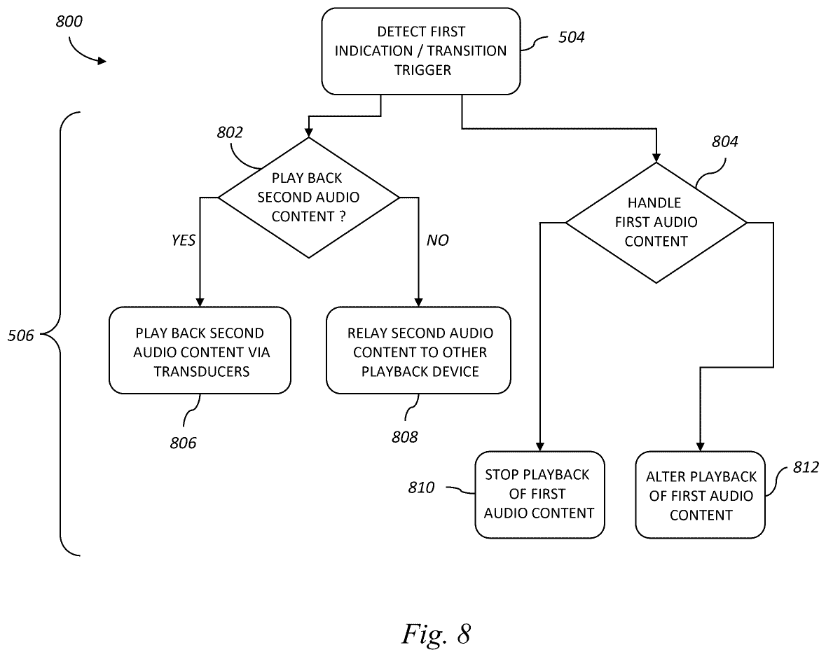

Based on the first indication detected at operation 504, the desktop playback device may transition from the first mode of operation to the second mode of operation. Accordingly, at operation 506, the desktop playback device may operate in the second mode of operation. As described further below, operating in the second mode of operation includes causing playback of the second audio content. Thus, in some examples, transitioning from the first mode of operation to the second mode of operation includes transitioning from playing back the first audio content to causing playback of the second audio content. Operation 506 may include various actions associated with handling the first and second audio content, examples of which are described further below with reference to FIG. 8.

While operating in the second mode, the desktop playback device 210 may detect, at operation 508, a second indication associated with termination of the telecommunications session. For example, the desktop playback device 210 may receive a signal or information from the external computing device 402 or another computing device that the telecommunication session has ended. In one example in which causing playback of the second audio content (at operation 506) involves transferring the second audio content to the wearable playback device 406 (as described further below), detecting the second indication may include detecting a signal from the wearable playback device 406 indicating that the telecommunications session has ended (e.g., the user terminated the telecommunications session via a control on the wearable playback device). As noted above, Wilberding '777 describes examples of transitioning playback of audio content from one playback device to another, including signaling between the playback devices to affect the transition.

Based on detecting the second notification at operation 508, the desktop playback device 210 may revert to operating in the first mode (operation 502), as shown in FIG. 5. As described above, in some examples, reverting to operation 502 includes reverting to playing back, via the transducers 214, the first audio content.

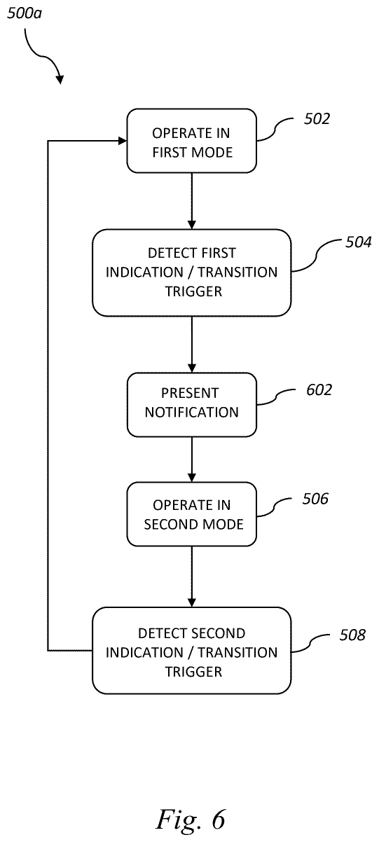

Referring to FIG. 6, in some examples, a variation 500a of the process 500 includes operation 602 of presenting a notification of the incoming second audio content to a user of the desktop playback device 210. As described above, in some examples, the first indication includes a signal, calendar notification, or an API call from the external computing device 402 or another computing device. Accordingly, the user may be unaware of the incoming second audio content (in contrast to examples in which the first indication is a transition trigger, such as a signal from the transition element 320, that may have been caused by the user). In some examples, operation 602 includes causing one or more illuminators associated with the transition element 320 to illuminate, change color, flash, or blink, to alert the user to the incoming second audio content. This may help to make it easier for the user to quickly actuate the transition element 320 to cause the desktop playback device to transition to the second mode of operation (operation 506). In other examples, operation 602 includes playing a chime or other notification sound via the transducers 214. As described above, the desktop playback device 210 may include one or more up-firing transducers (e.g., transducers 214c and/or 214g). In some examples, playing the notification chime or other sound includes playing the notification chime or other sound via at least the one or more up-firing transducers to create an impression to the user of the sound “rising” from the desktop playback device 210.

According to certain examples, the desktop playback device 210 can be grouped with one or more other playback devices, and the group of playback devices can be configured to play back audio content in synchrony, as described above with reference to FIGS. 1E and 1I-M, for example. Thus, in some examples, operation 502 can include playing back the first audio content in synchrony with one or more other playback devices in a playback group. Similarly, in some examples, operation 602 can include playing back the chime or other notification sound in synchrony with one or more other playback devices in a playback group.

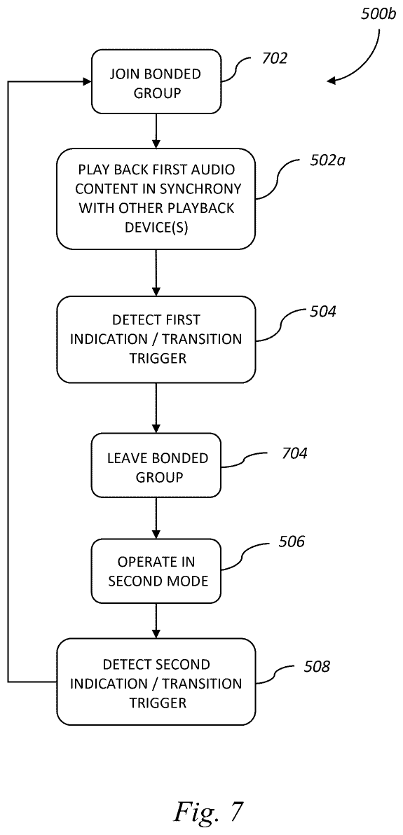

Referring to FIG. 7, there is illustrated another variation 500b of the process 500 in which the desktop playback device is configured, during operation 502a (an example of operation 502), to play back the first audio content in synchrony with one or more other playback devices.

Accordingly, at operation 702, the desktop playback device 210, prior to playing back the first audio content at operation 502, joins a playback group comprising the desktop playback device and at least a second playback device.

In this example, operation 502a includes playing back the first audio content via the plurality of audio transducers in substantial synchrony with corresponding playback of the first audio content via the second playback device. In further examples, operation 502a may include playing back the first audio content via (i) the first playback device according to a first playback responsibility and (ii) the second playback device according to a second playback responsibility. The first and second playback responsibilities may include responsibility for playing back one or more audio channels of the first audio content. For example, the playback group may be a group in which the playback devices in the group have responsibilities for playing back all the audio channels of the first audio content. In another example, the playback group may be a bonded group/zone (e.g., a stereo pair or home theater group) in which each playback device in the group has playback responsibility for a particular subset of the audio channels. Examples of synchronous playback among two or more playback devices are described above with reference to FIGS. 1E and 1I-M and in Kallai '080 referenced above.

According to certain examples, the process 500b includes, during the transition from operation 502 to operation 506, an operation 704 at which the desktop playback device 210 leaves the playback group. In some examples, although a user may be listening to the first audio content via a playback group of playback devices, the user may not wish to have the second audio content (associated with the telecommunication session) played using all the playback devices of the group. Further, if the playback group is a bonded zone, it may not make sense for the second audio content to be processed and played back in the bonded zone format. Accordingly, to handle the incoming second audio content, the desktop playback device 210 may leave the playback group at operation 704. In some such examples, operation 506 may include playing back, via the desktop playback device 210, the second audio content. Because the desktop playback device 210 has left the playgroup group, at operation 506, the desktop playback device can play back the second audio content without corresponding playback of the second audio content by any of the other playback devices in the playback group.

In some examples, upon detection of the second indication associated with termination of the telecommunications session, the desktop playback device 210 may rejoin the playback group, as indicated in FIG. 7.

In other examples, the process 500b may omit operation 704. Rather, transitioning from playing back the first audio content to causing playback of the second audio content may include playing back the second audio content via (i) the first playback device according to a third playback responsibility and (ii) the second playback device according to a fourth playback responsibility. In some examples, the fourth playback responsibility may include no responsibility for playing back the second audio content. Thus, even though the desktop playback device 210 may remain part of the playback group, the desktop playback device 210 may play back the second audio content without corresponding playback of the second audio content by the second playback device (or other playback devices in the group).

Referring now to FIG. 8, there is illustrated a process 800 (to be performed by the desktop playback device 210) that includes examples of operations that may form part of operation 506, according to certain aspects. In some examples, transitioning from the first mode of operation to the second mode of operation, and operating in the second mode of operation, include determining how to handle both the first audio content and the second audio content according to various different factors. Therefore, process 800 may include operation 802 of determining whether or not the desktop playback device 210, when operating in the second mode, is to play back the second audio content. The process 800 may further include operation 804 of determining how the desktop playback device, when operating in the second mode, is to handle the first audio content.

As described above, in some instances, when the desktop playback device 210 operates in the second mode (based on detecting the first indication/transition trigger at operation 504), the desktop playback device 210, at operation 806, plays back the second audio content via the transducers 214. In some examples, operation 806 includes adjusting one or more parameters of the audio drivers (or signal processing) associated with the transducers 214. For example, at operation 806, the desktop playback device 210 can reconfigure the transducers 214 for playing back speech. For example, audio corresponding to human speech may have different characteristics than audio corresponding to music content. Accordingly, to play back the second audio content, which may include human speech, parameters of the transducers can be altered to enhance speech quality. In some examples, configuring the transducers 214 for playing back speech includes adjusting one or more of volume settings of the transducers 214, equalization settings of the transducers 214, and/or or a distribution of audio channels of the second audio content among the transducers 214. For example, as described above, the desktop playback device 210 may include a plurality of audio transducers that are configured to output audio along a plurality of sound axes including at least one lateral sound axis and a vertical sound axis. In some examples, playing back the second audio content via the desktop playback device 210 at operation 806 includes causing one or more of the plurality of audio transducers 214 to output the second audio content along the vertical sound axis and the at least one lateral sound axis.

Further, as described above, playing back the first audio content at operation 502 may include playing back the first audio content via the transducers 214 according to a first radiation pattern, whereas playing back the second audio content at operation 806 may include playing back the second audio content via the transducers 214 according to a second radiation pattern. Accordingly, it will be appreciated that reverting to playback of the first audio content may include transitioning, based on the second indication (detected at operation 504), from (i) playing back the second audio content via the transducers 214 according to the second radiation pattern to (ii) playing back the first audio content via the transducers 214 according to the first radiation pattern. As described above, in some examples, the second radiation pattern is narrower than the first radiation pattern.

In certain examples, the telecommunication session hosted on the external computing device 402 can include multiple participants in addition to the user participating via the desktop playback device 210. In some examples, images corresponding to these participants are displayed on the display device 404. In such examples, the second audio content associated with the telecommunication session may include a plurality of audio streams, individual audio streams of the plurality of audio streams being associated with respective participants in the telecommunication session. In some examples, the desktop playback device 210 can be configured to distribute the plurality of audio streams among the plurality of audio transducers 214 such that the sound field spatially projects individual audio streams in a pattern corresponding to an arrangement of the participants displayed on display 404 of the external computing device 402.

In some examples, operation 802 includes determining that the desktop playback device is not to play back the second audio content, but rather that the second audio content is to be played back by another playback device. Accordingly, in such examples, operation 506 includes causing the other playback device to play back the second audio content. Thus, the process 800 may include operation 808 of transferring or relaying the second audio content from the desktop playback device 210 to another playback device. In some examples, the other playback device is the wearable playback device 406 (e.g., headphones, an extended reality device). Accordingly, operation 808 may include transferring the second audio content (received by the desktop playback device from the external computing device 402) to the wearable playback device 406 via the wireless communication link 408, as described above. In some such examples, operation 808 may include causing the desktop playback device 210 to deactivate (e.g., based on the first indication/transition trigger detected at operation 504 and the determination at operation 802), one or more amplifiers configured to drive the transducers 214 (as the transducers may not be needed to play back audio content when the second audio content is being played back by another playback device). Similarly, in such examples, reverting to playback back the first audio content at operation 502 may include activating the one or more amplifiers (e.g., based on the second indication detected at operation 508).

As described above, in some examples, the telecommunication session includes two-way communications. Thus, during the telecommunication session, the desktop playback device may receive, via a microphone, audio data corresponding to human speech, and send, via the first communication interface (e.g., the connection port 302 and associated communication link), the received audio data to the external computing device 402. In some examples, the microphone includes one or more microphones 115 of the desktop playback device 210, as described above. However, in examples in which the wearable playback device 406 is configured to play back the second audio content, the microphone may include one or more microphones disposed on the wearable playback device 406. Accordingly, in such examples, the desktop playback device 210 may receive the audio data from the wearable playback device 406 (e.g., via the wireless communication link 408) and send the audio data to the external computing device 402 or to another computing device involved in hosting the telecommunication session (e.g., via the links 103 and networks 102 described above with reference to FIG. 1B).

As described above, in some examples, when the desktop playback device transitions to the second mode of operation (e.g., based on detecting the first indication at operation 504), the desktop playback device ceases to play back the first audio content. Accordingly, in such examples, operation 506 includes an operation 810 of stopping playback of the first audio content.

In other examples, in the second mode, the desktop playback device 210 may continue to play back the first audio content via the transducers 214 in addition to causing playback of the second audio content (either by the desktop playback device itself or via another playback device, as described above). However, the desktop playback device 210 may alter one or more playback characteristics of the first audio content. Accordingly, in such examples, operation 506 includes an operation 812 of altering playback of the first audio content.

In some examples, operation 812 includes lowering a volume of the first audio content. For example, depending on the nature of the telecommunication session, the user may wish to continue listening to the first audio content, but at a reduced volume such that the user can also hear and understand the second audio content played in the course of the telecommunication session. In some examples, operating 812 includes changing a source of the first audio content, for example, changing the genre or playlist of the first audio content. For example, depending on the nature of the telecommunication session, the user may wish to play a different type of first audio content, or to play a particular track or playlist that has been curated for the telecommunication session.

It will further be appreciated that, in some examples, altering at least one playback characteristic of the first audio content at operation 812 may include stopping playback of the first audio content (operation 810). Thus, in some instances, operation 810 is an example of operation 812.

In some examples, the determination at operation 804 of how to handle the first audio content (e.g., stop playback, alter the playback, etc.) may be based at least in part on one or more conditions associated with the telecommunication session. For example, the determination at operation 804 may be based on the identity of one or more participants in the telecommunication session or the type of telecommunication session (e.g., one in which the user must actively participate vs one in which the user is merely a passive listener). In some examples, information regarding condition(s) associated with the telecommunication session may be provided by the external computing device and can be processed (e.g., via the processor(s) 112a) according to certain rules or instructions that have been previously configured by the user. For example, the user may configure the desktop playback device 210 to always cease playback of the first audio content (operation 810) if a telecommunication session involves participant X.

In some examples, the determination at operation 804 (and optionally also at operation 802) may be based at least in part on the source of the first indication/transition trigger detected at operation 504. For example, the user may configure a response of the desktop playback device 210 to a transition trigger received via the transition element 320. For example, the desktop playback device 210 can be configured such that, if the transition element 320 is actuated to cause a transition, the desktop playback device 210 automatically (e.g., without further input from the user) ceases playback of the first audio content and causes playback of the second audio content via the transducers 214. In other examples, in the first indication includes a signal from the external computing device 402, such as a signal indicating that a telecommunication session has been initiated by a particular user contact or a calendar notification, for example, the determination at operation 802 may be based at least in part on the identity of the user contact or certain information included in the calendar notification or API call (e.g., information about the type of telecommunication session). Numerous other examples and variations will be apparent in light of this disclosure and are intended to be within the scope of this disclosure.

Thus, aspects and examples provide a desktop playback device that can be configured to provide an enhanced user experience in the desktop environment, at least in part through dynamic, configurable handling of the first and second audio content as described above, and corresponding methods of operating the desktop playback device.

### V. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VI. Additional Examples

The following examples pertain to further embodiments, from which numerous permutations and configurations will be apparent.

Example 1 provides a playback device comprising: a plurality of audio transducers; a first communication interface; at least one processor; and at least one non-transitory computer-readable storage medium storing program instructions that are executable by the at least one processor to cause the playback device to play back first audio content via the plurality of audio transducers, while playing back the first audio content, detect, via the first communication interface, a first indication of incoming second audio content associated with a telecommunications session hosted on an external computing device, based on the first indication, transition from playing back the first audio content to causing playback of the second audio content, detect, after detecting the first indication, a second indication associated with termination of the telecommunications session, and revert, based on the second indication, to playback of the first audio content via the plurality of audio transducers.

Example 2 includes the playback device of Example 1, wherein the playback device is a first playback device, wherein the program instructions comprise program instructions that are executable by the at least one processor to cause the playback device to join, prior to playing back the first audio content, a playback group comprising the first playback device and a second playback device, and wherein playing back the first audio content comprises playing back the first audio content via the plurality of audio transducers in substantial synchrony with corresponding playback of the first audio content via the second playback device.

Example 3 includes the playback device of Example 2, wherein transitioning from playing back the first audio content to causing playback of the second audio content comprises ungrouping from the playback group and playing back the second audio content via the plurality of audio transducers such that the second audio content is played back via the first playback device in an absence of corresponding playback of the second audio content via the second playback device.

Example 4 includes the playback device of one of Examples 2 or 3, wherein the program instructions comprise program instructions that are executable by the at least one processor to cause the playback device to re-join, after receiving the second indication, the playback group, and wherein reverting to playback of the first audio content comprises playing back the first audio content via the plurality transducers in substantial synchrony with corresponding playback of the first audio content via the second playback device.

Example 5 includes playback device of Example 2, wherein playing back the first audio content comprises playing back the first audio content via (i) the first playback device according to a first playback responsibility and (ii) the second playback device according to a second playback responsibility; and wherein transitioning from playing back the first audio content to causing playback of the second audio content comprises playing back the second audio content via (i) the first playback device according to a third playback responsibility and (ii) the second playback device according to a fourth playback responsibility.

Example 6 includes the playback device of any one of Examples 1-5, wherein: playing back the first audio content comprises playing back the first audio content via the plurality of audio transducers according to a first radiation pattern; causing playback of the second audio content comprises playing back the second audio content via the plurality of audio transducers according to a second radiation pattern; and reverting to playback of the first audio content comprises transitioning, based on the second indication, from (i) playing back the second audio content via the plurality of audio transducers according to the second radiation pattern to (ii) playing back the first audio content via the plurality of audio transducers according to the first radiation pattern.

Example 7 includes the playback device of Example 6, wherein the second radiation pattern in narrower than the first radiation pattern.

Example 8 include the playback device of one of Examples 6 or 7, wherein the second radiation pattern has a maximum magnitude is aligned with a first direction with respect to the first playback device; and wherein the program instructions comprise program instructions that are executable by the at least one processor to cause the playback device to determine, via one or more sensors of the first playback, a first position of a user's head aligned with a second direction with respect to the first playback device, and adjusting, based on the determined first position, the second radiation pattern, wherein the adjusted radiation pattern has an adjusted maximum magnitude substantially aligned with the second direction.

Example 9 includes the playback device of any one of Examples 1-8, wherein the playback device comprises one or more amplifiers coupled to the plurality of audio transducers, and wherein the program instructions comprise program instructions that are executable by the at least one processor to cause the playback device to: deactivate, based on the first indication, the one or more amplifiers; and activate, based on the second indication, the one or more amplifiers.

Example 10 includes the playback device of Example 9, wherein causing playback of the second audio content comprises sending, via a second communication interface, the second audio content to a wearable playback device.

Example 11 includes the playback device of Example 10, wherein the program instructions comprise program instructions that are executable by the at least one processor to cause the playback device to: receive, via a third communication interface, third audio content; and cause, via the second communication interface, playback of the third audio content.

Example 12 includes the playback device of any one of Examples 1-9, further comprising a second communication interface; wherein the second communication interface is a wireless communication interface configured to establish a connection to a wireless data network; and wherein the program instructions comprise program instructions that are executable by the at least one processor to cause the playback device to receive the first audio content via the wireless communication interface.

Example 13 includes the playback device of any one of Examples 1-12, wherein the program instructions comprise program instructions that are executable by the at least one processor to cause the playback device to (i) receive, via a microphone, audio data corresponding to human speech, and (ii) send, via the first communication interface, the received audio data to the external computing device.

Example 14 includes the playback device of Example 13, wherein the microphone is disposed on a wearable playback device.

Example 15 includes the playback device of any one of Examples 1-14, wherein the playback device is a first playback device, wherein the first playback device comprises a first zone, and wherein the program instructions comprise program instructions that are executable by the at least one processor to cause the first playback device to cause, via another playback device in a second zone, playback of third audio content in response to the first indication received by the first playback device.

Example 16 includes the playback device of any one of Examples 1-15, wherein the first communication interface includes a connection port for coupling to the external computing device.

Example 17 includes the playback device of Example 16, wherein the connection port includes at least one of a USB-C port or an HDMI port.

Example 18 includes the playback device of any one of Examples 1-17, wherein the first indication includes a calendar notification from the external computing device indicating that the telecommunications session is scheduled to be initiated on the external computing device.

Example 19 includes the playback device of Example 18, further comprising a clock; wherein the calendar notification includes a scheduled time for initiation of the telecommunications session on the external computing device, and wherein to transition from transition from playing back the first audio content to causing playback of the second audio content, the program instructions comprise program instructions that are executable by the at least one processor to cause the playback device to cease playing back the first audio content at a time based on the scheduled time.

Example 20 includes the playback device of any one of Examples 1-19 further comprising a housing having an elongated form factor; wherein the plurality of audio transducers, the first communication interface, the at least one processor, and the at least one non-transitory computer-readable storage medium are disposed in the housing.

Example 21 includes the playback device of Example 20, wherein the playback device further comprises a user interface including a transition element; and wherein the first indication includes a signal from the transition element.

Example 22 includes the playback device of Example 21, wherein the transition element includes a capacitive touch sensor, a button, or a switch.

Example 23 includes the playback device of Example 20, further comprising a user interface accessible via the housing, wherein the user interface comprises one or more contact access controls configured to facilitate establishing telecommunications sessions with respective one or more user contacts, and at least one audio control for controlling playback of audio content by the playback device.

Example 24 includes the playback device of Example 23, wherein the one or more contact access controls each include a status indicator indicating an availability of the respective user contact for telecommunications sessions.

Example 25 includes the playback device of any one of Examples 1-24, wherein the program instructions comprise program instructions that are executable by the at least one processor to cause the playback device to, based on the first indication, configure the plurality of audio transducers for playing back speech.

Example 26 includes the playback device of Example 25, wherein configuring the plurality of audio transducers for playing back speech includes adjusting one or more of: volume settings of the plurality of audio transducers; equalization settings of the plurality of audio transducers; and/or distribution of audio channels of the second audio content among the plurality of audio transducers.

Example 27 includes the playback device of any one of Examples 1-26, wherein the plurality of audio transducers are configured to output audio along a plurality of sound axes including at least one lateral sound axis and a vertical sound axis, wherein the lateral sound axis is angled with respect to a horizontal axis of the playback device by less than 30 degrees and wherein the vertical sound axis is angled with respect to the horizontal axis by 50-90 degrees; and wherein the program instructions comprise program instructions that are executable by the at least one processor to cause the playback device to, based on the first indication, cause playback of the second audio content by causing one or more of the plurality of audio transducers to output the second audio content along the vertical sound axis and the at least one lateral sound axis.

Example 28 includes the playback device of Example 27, wherein the program instructions comprise program instructions that are executable by the at least one processor to cause the playback device to, based on the first indication, cause at least one of the audio transducers to output a notification sound, wherein the notification sound is at least partially output along the vertical sound axis.

Example 29 provides a playback device comprising: a housing; a user interface accessible via the housing; a plurality of audio transducers disposed in the housing; a communication interface including a connection port for coupling to an external computing device; and at least one processor. The playback device further comprises at least one non-transitory computer-readable storage medium coupled to the at least one processor and storing program instructions that are executable by the at least one processor to cause the playback device to: operate in a first mode in which the playback device plays back, via the plurality of audio transducers, first audio content from a first source; while operating in the first mode, detect a first transition trigger from one of the user interface or the external computing device, the first transition trigger indicating incoming second audio content associated with a telecommunications session hosted on the external computing device; based on the first transition trigger, operate in a second mode, wherein to operate in the second mode includes to alter at least one playback characteristic of the first audio content relative to the first mode, and process the second audio content, while operating in the second mode, detect a second transition trigger from one of the user interface or the external computing device, and based on the second transition trigger, revert to operating in the first mode.

Example 30 includes the playback device of Example 29, wherein to alter the at least one playback characteristic of the first audio content includes to cease playing back the first audio content via the plurality of audio transducers.

Example 31 includes the playback device of Example 29, wherein to alter the at least one playback characteristic of the first audio content includes to reduce a volume of playback of the first audio content.

Example 32 includes the playback device of one of Examples 29 or 31, wherein to alter the at least one playback characteristic of the first audio content includes to: select a second source of the first audio content; and play back, via the plurality of audio transducers, the first audio content from the second source.

Example 33 includes the playback device of any one of Examples 29-32, wherein the housing has an elongated form factor.

Example 34 includes the playback device of any one of Examples 29-33, wherein the communication interface further includes a wireless communication interface configured to establish a connection to one or more wireless data networks.

Example 35 includes the playback device of Example 34, wherein to process the second audio content comprises to: receive the second audio content from the external computing device; transmit the second audio content from the playback device to another playback device via the wireless communication interface; and cause the other playback device to play back the second audio content.

Example 36 includes the playback device of Example 35, wherein the other playback device is a wearable playback device.

Example 37 includes the playback device of any one of Examples 34-36, wherein the program instructions comprise program instructions that are executable by the at least one processor to cause the playback device to receive the first audio content via the wireless communication interface.

Example 38 includes the playback device of any one of Examples 29-34 or 37, wherein to process the second audio content comprises to play back the second audio content via the plurality of audio transducers.

Example 39 includes the playback device of Example 38, wherein the plurality of audio transducers are configured to output audio along a plurality of sound axes including at least one lateral sound axis and a vertical sound axis, wherein the lateral sound axis is angled with respect to a horizontal axis of the playback device by less than 30 degrees and wherein the vertical sound axis is angled with respect to the horizontal axis by 50-90 degrees; and wherein to play back the second audio content, the program instructions comprise program instructions that are executable by the at least one processor to cause the playback device to play back the second audio content by causing one or more of the plurality of audio transducers to output the second audio content along the vertical sound axis and the at least one lateral sound axis.

Example 40 includes the playback device of Example 39, wherein the program instructions comprise program instructions that are executable by the at least one processor to cause the playback device to, based on the first transition trigger, cause at least one of the audio transducers to output a notification sound, wherein the notification sound is at least partially output along the vertical sound axis.

Example 41 includes the playback device of any one of Examples 29-40, wherein the first transition trigger includes a notification signal from the external computing device, the notification signal indicating initiation of the telecommunications session on the external computing device.

Example 42 includes the playback device of any one of Examples 29-40, wherein the first transition trigger includes a calendar notification from the external computing device indicating that the telecommunications session is scheduled to be initiated on the external computing device.

Example 43 includes the playback device of Example 42, further comprising a clock; wherein the calendar notification includes a scheduled time for initiation of the telecommunications session on the external computing device, and wherein to alter the at least one playback characteristic of the first audio content, the program instructions comprise program instructions that are executable by the at least one processor to cause the playback device to cease playback of the first audio content at a time based on the scheduled time.

Example 44 includes the playback device of any one of Examples 29-43, wherein the user interface comprises at least one of a transition element, one or more contact access controls configured to facilitate establishing telecommunications sessions with respective one or more user contacts, or at least one audio control for controlling playback of audio content by the playback device.

Example 45 includes the playback device of Example 44, wherein the user interface comprises the transition element, and wherein at least one of the first transition trigger or the second transition trigger includes a signal from the transition element.

Example 46 includes the playback device of Example 45, wherein the transition element includes a capacitive touch sensor, a button, or a switch.

Example 47 includes the playback device of any one of Examples 44-46, wherein the user interface comprises the one or more contact access controls, and wherein the one or more contact access controls each include a status indicator indicating an availability of the respective user contact for telecommunications sessions.

Example 48 includes the playback device of any one of Examples 29-47, wherein the second transition trigger indicates termination of the telecommunications session.

Example 49 includes the playback device of any one of Examples 29-48, wherein the playback device is a first playback device, wherein the program instructions comprise program instructions that are executable by the at least one processor to cause the playback device to join, prior to playing back the first audio content, a playback group comprising the first playback device and a second playback device, and wherein playing back the first audio content comprises playing back the first audio content via the plurality of audio transducers in substantial synchrony with corresponding playback of the first audio content via the second playback device.

Example 50 provides a playback device comprising: a housing; a plurality of audio transducers disposed in the housing; at least one processor disposed in the housing; and at least one non-transitory computer-readable storage medium disposed in the housing and coupled to the at least one processor and storing program instructions that are executable by the at least one processor to cause the playback device to play back first audio content via the plurality of audio transducers, while playing back the first audio content, detect a first indication of initiation of a telecommunication session hosted on an external computing device, based on the first indication, (i) cease playing back the first audio content via the plurality of audio transducers, (ii) detect second audio content associated with the telecommunications session, and (iii) cause another playback device to play back the second audio content, after causing the other playback device to play back the second audio content, detect a second indication of termination of the telecommunication session, and based on the second indication, revert to playing back the first audio content via the plurality of audio transducers.

Example 51 includes the playback device of Example 50, wherein the housing has an elongated form factor.

Example 52 includes the playback device of one of Examples 50 or 51, further comprising: a wired communication interface including a connection port for coupling to the external computing device; and a wireless communication interface configured to establish a connection to one or more wireless data networks; wherein to detect the second audio content includes to receive the second audio content from the external computing device via the connection port; and wherein to cause the other playback device to play back the second audio content includes to transmit the second audio content to the other playback device via the wireless communication interface.

Example 53 includes the playback device of Example 52, wherein the first indication includes a calendar notification from the external computing device.

Example 54 includes the playback device of one of Examples 52 or 53, wherein the program instructions comprise program instructions that are executable by the at least one processor to cause the playback device to receive the first audio content via the wireless communication interface.

Example 55 includes the playback device of any one of Examples 50-54, further comprising a user interface accessible via the housing, the user interface comprising a transition element, wherein the first indication includes a signal from the transition element.

Example 56 includes the playback device of Example 55, wherein the transition element includes a capacitive touch sensor, a button, or a switch.

Example 57 includes the playback device of one of Examples 55 or 56, wherein the user interface further comprises one or more contact access controls configured to facilitate establishing telecommunications sessions with respective one or more user contacts.

Example 58 includes the playback device of Example 57, wherein the one or more contact access controls each include a status indicator indicating an availability of the respective user contact for telecommunications sessions.

Example 59 provides a playback device comprising: a housing; an audio transducer assembly disposed in the housing and configured to produce a sound field tailored for a near-field acoustic region of the playback device; a wired communication interface including a connection port for coupling to an external computing device; a wireless communication interface configured to establish wireless communications via one or more data networks; a user interface accessible via the housing, the user interface including one or more contact access controls configured to facilitate establishing telecommunication sessions with respective one or more user contacts, and at least one audio control for controlling playback of audio content by the playback device; and at least one processor. The playback device further comprises at least one non-transitory computer-readable storage medium coupled to the at least one processor and storing program instructions that are executable by the at least one processor to cause the playback device to receive, via the wired communication interface, audio content associated with a telecommunication session hosted on the external computing device, and play back the audio content via the audio transducer assembly.

Example 60 includes the playback device of Example 59, wherein the one or more contact access controls each include a status indicator indicating an availability of the respective user contact for telecommunications sessions.

Example 61 includes the playback device of one of Examples 59 or 60, wherein the connection port includes at least one of a USB-C port or an HDMI port.

Example 62 includes the playback device of any one of Examples 59-61, wherein the audio transducer assembly comprises a plurality of audio transducers configured to output audio along a plurality of sound axes including at least one lateral sound axis and a vertical sound axis, wherein the lateral sound axis is angled with respect to a horizontal axis of the playback device by less than 30 degrees and wherein the vertical sound axis is angled with respect to the horizontal axis by 50-90 degrees.

Example 63 includes the playback device of Example 62, wherein the program instructions comprise program instructions that are executable by the at least one processor to cause the playback device to play back the audio content by causing one or more of the plurality of audio transducers to output the audio content along the vertical sound axis and the at least one lateral sound axis.

Example 64 includes the playback device of Example 63, wherein the audio content includes a plurality of audio streams, individual audio streams of the plurality of audio streams being associated with respective participants in the telecommunications session; and wherein, to play back the audio content, the program instructions comprise program instructions that are executable by the at least one processor to cause the playback device to distribute the plurality of audio streams among the plurality of audio transducers such that the sound field spatially projects individual audio streams of the plurality of audio streams in a pattern corresponding to an arrangement of the participants displayed on a video display of the external computing device.

Example 65 includes the playback device of any one of Examples 59-64, further comprising a microphone assembly.

Example 66 includes the playback device of any one of Examples 55-61, wherein the near-field acoustic region of the playback device extends up to 6 feet from a front of the playback device.

Example 67 includes the playback device of any one of Examples 59-66, wherein the housing has an elongated form factor.

Example 68 includes the playback device of any one of Examples 59-67, wherein the at least one audio control of the user interface includes a transition element configured to cause the playback device to cease playback of first audio content and prepare for rendering of the audio content associated with the telecommunications session hosted on the external computing device.

Example 69 provides a playback device comprising: a plurality of audio transducers configured to output audio along a plurality of sound axes including at least one lateral sound axis and a vertical sound axis, wherein the lateral sound axis is angled with respect to a horizontal axis of the playback device by less than 30 degrees and wherein the vertical sound axis is angled with respect to the horizontal axis by 50-90 degrees; a communication interface including a connection port for coupling to an external computing device; and one or more processors. The playback device further comprises at least one tangible computer-readable storage medium storing program instructions that, when executed by the one or more processors, cause the playback device to receive, via the connection port, audio content from the external computing device, the audio content including a plurality of audio streams, individual audio streams of the plurality of audio streams being associated with respective participants in a telecommunications session, and play back the audio content using the plurality of audio transducers, including to distribute the plurality of audio streams among the plurality of audio transducers so as to produce a sound field that spatially projects individual audio streams of the plurality of audio streams in a pattern corresponding to an arrangement of the participants displayed on a video display of the external computing device.

Example 70 provides a playback device comprising: a housing having an elongated form factor; a user interface accessible via the housing; a wired communication interface disposed in the housing and including a connection port for coupling to the external computing device; a wireless interface disposed in the housing, and configured to establish a connection to one or more wireless data networks; an audio transducer assembly disposed in the housing; and at least one processor disposed in the housing. The playback device further comprises at least one non-transitory computer-readable storage medium disposed in the housing and coupled to the at least one processor and storing program instructions that are executable by the at least one processor to cause the playback device to play back audio content via the audio transducer assembly, while playing back the audio content, detect a control signal from one of the user interface or the external computing device, the control signal including an indication of initiation of a telecommunications session hosted by the external computing device, and based on the control signal, modify playback of the audio content.

Example 71 includes the playback device of Example 70, wherein to modify playback of the audio content, the program instructions comprise program instructions that are executable by the at least one processor to cause the playback device to: cease playing back first audio content via the audio transducer assembly; and play back second audio content via the audio transducer assembly, wherein the second audio content is associated with the telecommunications session.

Example 72 includes the playback device of Example 71, wherein the second audio content includes human speech.

Example 73 includes the playback device of Example 70, wherein to modify playback of the audio content, the program instructions comprise program instructions that are executable by the at least one processor to cause the playback device to: cease playing back first audio content via the audio transducer assembly; detect second audio content associated with the telecommunications session; and cause another playback device to play back the second audio content.

Example 74 includes the playback device of Example 70, wherein to modify playback of the audio content, the program instructions comprise program instructions that are executable by the at least one processor to cause the playback device to: modify at least one playback parameter associated with first audio content played back via the audio transducer assembly; and while playing back the first audio content via the audio transducer assembly, play back second audio content via the audio transducer assembly, the second audio content being associated with the telecommunications session.

Example 75 includes the playback device of Example 74, wherein the at least one playback parameter associated with the first audio content includes volume, and/or a source of the first audio content.

Example 76 includes the playback device of Example 70, wherein the control signal is from the external computing device and includes information specifying a category of a participant in the telecommunications session, and wherein to modify playback of the audio content, the program instructions comprise program instructions that are executable by the at least one processor to cause the playback device to: based on the category of the participant being a first category, (i) cease playing back the first audio content, and (ii) play back, via the audio transducer assembly, second audio content associated with the telecommunications session; or based on the category of the participant being a second category, (i) play back the first audio content via the audio transducer assembly, wherein the first audio content is music, and (ii) play back the second audio content via the audio transducer assembly, the second audio content being associated with the telecommunications session.

Example 77 includes the playback device of any one of Examples 70-76, wherein the user interface comprises a transition element, and wherein the control signal is from the transition element.

Example 78 includes the playback device of Example 77, wherein the transition element includes a capacitive touch sensor, a button, or a switch.

Example 79 include the playback device of any one of Examples 70-78, wherein the user interface comprises one or more contact access controls configured to facilitate establishing telecommunications sessions with respective one or more user contacts.

Example 80 includes the playback device of Example 79, wherein the one or more contact access controls each include a status indicator indicating an availability of the respective user contact for telecommunications sessions.

Example 81 includes the playback device of any one of Examples 32-42, further comprising a microphone assembly.

Example 82 includes the playback device of any one of Examples 70-81, wherein the connection port includes at least one of a USB-C port or an HDMI port.

Example 83 includes the playback device of any one of Examples 70-82, wherein the audio transducer assembly comprises a plurality of audio transducers configured to output audio along a plurality of sound axes including at least one lateral sound axis and a vertical sound axis, wherein the lateral sound axis is angled with respect to a horizontal axis of the playback device by less than 30 degrees and wherein the vertical sound axis is angled with respect to the horizontal axis by 50-90 degrees; and wherein the program instructions comprise program instructions that are executable by the at least one processor to cause the playback device to, based on the control signal, cause at least one of the audio transducers to output a notification sound, wherein the notification sound is at least partially output along the vertical sound axis.

Example 84 is a method of operating a playback device, the method comprising: playing back, with the playback device, first audio content via a plurality of audio transducers of the playback device; while playing back the first audio content, detecting, via a first communication interface of the playback device, a first indication of incoming second audio content associated with a telecommunications session hosted on an external computing device; based on the first indication, transitioning the playback device from playing back the first audio content to causing playback of the second audio content; detecting, by the playback device and after detecting the first indication, a second indication associated with termination of the telecommunications session; and reverting, based on the second indication, to playback of the first audio content via the plurality of audio transducers of the playback device.

1. A playback device comprising:
a plurality of audio transducers;
a first communication interface;
at least one processor; and
at least one non-transitory computer-readable storage medium storing program instructions that are executable by the at least one processor to cause the playback device to play back first audio content via the plurality of audio transducers,
while playing back the first audio content, detect, via the first communication interface, a first indication of incoming second audio content associated with a telecommunications session hosted on an external computing device,
based on the first indication, transition from playing back the first audio content to causing playback of the second audio content,
detect, after detecting the first indication, a second indication associated with termination of the telecommunications session, and
revert, based on the second indication, to playback of the first audio content via the plurality of audio transducers.

2. (canceled)

3. (canceled)

4. (canceled)

5. (canceled)

6. The playback device of claim 1, wherein:
playing back the first audio content comprises playing back the first audio content via the plurality of audio transducers according to a first radiation pattern;
causing playback of the second audio content comprises playing back the second audio content via the plurality of audio transducers according to a second radiation pattern; and
reverting to playback of the first audio content comprises transitioning, based on the second indication, from (i) playing back the second audio content via the plurality of audio transducers according to the second radiation pattern to (ii) playing back the first audio content via the plurality of audio transducers according to the first radiation pattern.

7. The playback device of claim 6, wherein the second radiation pattern is narrower than the first radiation pattern.

8. The playback device of claim 6, wherein the second radiation pattern has a maximum magnitude is aligned with a first direction with respect to the first playback device; and
wherein the program instructions comprise program instructions that are executable by the at least one processor to cause the playback device to determine, via one or more sensors of the playback, a first position of a user's head aligned with a second direction with respect to the playback device, and adjusting, based on the determined first position, the second radiation pattern, wherein the adjusted radiation pattern has an adjusted maximum magnitude substantially aligned with the second direction.

9. (canceled)

10. (canceled)

11. (canceled)

12. The playback device of claim 1, further comprising a second communication interface;
wherein the second communication interface is a wireless communication interface configured to establish a connection to a wireless data network; and
wherein the program instructions comprise program instructions that are executable by the at least one processor to cause the playback device to receive the first audio content via the wireless communication interface.

13. (canceled)

14. (canceled)

15. (canceled)

16. The playback device of claim 1, wherein the first communication interface includes a connection port for coupling to the external computing device; and
wherein the connection port includes at least one of a USB-C port or an HDMI port.

17. (canceled)

18. (canceled)

19. (canceled)

20. (canceled)

21. (canceled)

22. (canceled)

23. (canceled)

24. (canceled)

25. (canceled)

26. (canceled)

27. The playback device of claim 1, wherein the plurality of audio transducers are configured to output audio along a plurality of sound axes including at least one lateral sound axis and a vertical sound axis, wherein the lateral sound axis is angled with respect to a horizontal axis of the playback device by less than 30 degrees and wherein the vertical sound axis is angled with respect to the horizontal axis by 50-90 degrees; and
wherein the program instructions comprise program instructions that are executable by the at least one processor to cause the playback device to, based on the first indication, cause playback of the second audio content by causing one or more of the plurality of audio transducers to output the second audio content along the vertical sound axis and the at least one lateral sound axis.

28. The playback device of claim 27, wherein the program instructions comprise program instructions that are executable by the at least one processor to cause the playback device to, based on the first indication, cause at least one of the audio transducers to output a notification sound, wherein the notification sound is at least partially output along the vertical sound axis.

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. A playback device comprising:
a housing;
an audio transducer assembly disposed in the housing and configured to produce a sound field tailored for a near-field acoustic region of the playback device;
a wired communication interface including a connection port for coupling to an external computing device;
a wireless communication interface configured to establish wireless communications via one or more data networks;
a user interface accessible via the housing, the user interface including one or more contact access controls configured to facilitate establishing telecommunications sessions with respective one or more user contacts, and at least one audio control for controlling playback of audio content by the playback device;
at least one processor; and
at least one non-transitory computer-readable storage medium coupled to the at least one processor and storing program instructions that are executable by the at least one processor to cause the playback device to
receive, via the wired communication interface, audio content associated with a telecommunications session hosted on the external computing device, and
play back the audio content via the audio transducer assembly.

60. The playback device of claim 59, wherein the one or more contact access controls each include a status indicator indicating an availability of a respective user contact for telecommunications sessions.

61. The playback device of claim 59, wherein the connection port includes at least one of a USB-C port or an HDMI port.

62. The playback device of claim 59, wherein the audio transducer assembly comprises a plurality of audio transducers configured to output audio along a plurality of sound axes including at least one lateral sound axis and a vertical sound axis, wherein the lateral sound axis is angled with respect to a horizontal axis of the playback device by less than 30 degrees and wherein the vertical sound axis is angled with respect to the horizontal axis by 50-90 degrees; and
wherein the program instructions comprise program instructions that are executable by the at least one processor to cause the playback device to play back the audio content by causing one or more of the plurality of audio transducers to output the audio content along the vertical sound axis and the at least one lateral sound axis.

63. (canceled)

64. The playback device of claim 62, wherein the audio content includes a plurality of audio streams, individual audio streams of the plurality of audio streams being associated with respective participants in the telecommunications session; and wherein, to play back the audio content, the program instructions comprise program instructions that are executable by the at least one processor to cause the playback device to distribute the plurality of audio streams among the plurality of audio transducers such that the sound field spatially projects individual audio streams of the plurality of audio streams in a pattern corresponding to an arrangement of the participants displayed on a video display of the external computing device.

65. (canceled)

66. The playback device of claim 59, wherein the near-field acoustic region of the playback device extends up to 6 feet from a front of the playback device.

67. (canceled)

68. (canceled)

69. (canceled)

70. A playback device comprising:
a plurality of audio transducers;
a communication interface including at least one connection port for coupling to an external computing device;
at least one processor; and
at least one non-transitory computer-readable storage medium storing program instructions that are executable by the at least one processor to cause the playback device to
operate in a first mode in which the playback device plays back, via the plurality of audio transducers and according to a first radiation pattern, first audio content from a first source,
detect, via the communication interface, an indication of incoming second audio content from the external computing device,
based on the indication, operate in a second mode in which the playback device plays back, via the plurality of audio transducers and according to a second radiation pattern, the second audio content received from the external computing device,
detect a transition trigger, and
transition, based on the transition trigger, from playing back the second audio content via the plurality of audio transducers according to the second radiation pattern to playing back the first audio content via the plurality of audio transducers according to the first radiation pattern;
wherein the second radiation pattern is narrower than the first radiation pattern.

71. The playback device of claim 70, wherein the at least one connection port includes a USB-C port.

72. The playback device of claim 71, wherein the at least one connection port further includes an HDMI port for coupling to the first source.

73. The playback device of claim 70, wherein the second radiation pattern has a maximum magnitude is aligned with a first direction with respect to the playback device; and
wherein the program instructions comprise program instructions that are executable by the at least one processor to cause the playback device to:
determine, via one or more sensors of the playback, a first position of a user's head aligned with a second direction with respect to the playback device, and
adjust, based on the determined first position, the second radiation pattern, wherein the adjusted radiation pattern has an adjusted maximum magnitude substantially aligned with the second direction.

74. The playback device of claim 70, wherein the second radiation pattern is configured to produce a sound field tailored for a near-field acoustic region of the playback device.

75. The playback device of claim 70, wherein the second audio content is associated with a telecommunications session hosted on an external computing device.
